(19) United States
(12) Patent Application Publication
(10) Pub. No.: US 2026/0237232 A1
(43) Pub. Date: Aug. 13, 2026

(54) SYSTEM AND METHOD FOR REAL-TIME BINARY CODE TRANSLATION ON APPAREL

(71) Applicant: Darrien Jackson, McDonough, GA (US)

(72) Inventor: Darrien Jackson, McDonough, GA (US)

(21) Appl. No.: 19/460,135

(22) Filed: Jan. 26, 2026

Related U.S. Application Data
(60) Provisional application No. 63/755,332, filed on Feb. 7, 2025.

(51) Int. Cl. G06V 30/142; G06V 20/20

(52) U.S. Cl. CPC G06V 30/142; G06V 20/20

(57) ABSTRACT

A system for translating binary code patterns on garments to text may include a custom garment displaying a unique binary code pattern and a mobile computing device. The mobile computing device may comprise an image capture device configured to capture image data, a display, a processor, and memory storing instructions. When executed by the processor, the instructions may cause the mobile computing device to activate the image capture device in response to user input, capture image data of the binary code pattern on the custom garment, and process the captured image data using optical character recognition to identify binary digits within the binary code pattern. The mobile computing device may convert the identified binary digits to text using a conversion algorithm and display the text on the display in real-time. The unique binary code pattern may encode identification information for a specific user.

### RELATED APPLICATION

Under provisions of 35 U.S.C. § 119(e), the Applicant claims benefit of U.S. Provisional Application No. 63/755,332 filed on Feb. 7, 2025, and having inventors in common, which is incorporated herein by reference in its entirety.

It is intended that each of the referenced applications may be applicable to the concepts and embodiments disclosed herein, even if such concepts and embodiments are disclosed in the referenced application(s) with different limitations and configurations and described using different examples and terminology.

### FIELD OF DISCLOSURE

The present disclosure generally relates to optical character recognition (OCR) and digital image processing. More specifically, it pertains to mobile applications for real-time translation of encoded information on physical objects, particularly binary code printed on custom clothing items into human-readable ASCII text.

### BACKGROUND

In some situations, individuals may seek to incorporate technology into fashion items to create unique brand experiences or provide functional capabilities. For example, clothing manufacturers may explore ways to integrate digital elements with physical garments to enhance consumer engagement and product differentiation. Thus, the conventional strategy is to add QR codes, RFID tags, or NFC chips to apparel items. This often causes problems because the conventional strategy does not create a seamless integration between the garment design and the interactive technology. For example, QR codes may appear as generic additions rather than integral design elements.

Conventional optical character recognition (OCR) systems may be designed to recognize and translate various types of text and characters. These systems may typically focus on recognizing and translating natural languages or common character sets. OCR technology may be widely used in applications such as document scanning, text extraction from images, and language translation tools. Existing OCR applications may not be optimized for recognizing and translating specialized codes or symbols. Binary code recognition may not be a primary function of mainstream OCR systems. The translation of binary sequences to ASCII text may require manual input into web-based converters.

Mobile applications may be developed for a wide range of purposes. These applications may include entertainment, productivity, and brand engagement functionalities. Lightweight, single-purpose applications specifically designed to interact with fashion items may be less common. General-purpose OCR applications may include numerous features beyond basic translation. These multi-featured applications may require significant processing power and memory resources. Data storage and internet connectivity may be required for cloud-based processing in conventional OCR applications.

In the field of fashion and brand identity, conventional systems may incorporate technology in various ways. Some clothing items may include QR codes or RFID tags for inventory management or customer engagement purposes. Smart fabrics and wearable technology may also be integrated into clothing to provide additional functionality. The integration of OCR technology with fashion branding may be limited. Opportunities for creating unique and technologically advanced brand identities may be missed. Interactive and engaging experiences for consumers through their clothing may be lacking.

Current methods for translating binary code to ASCII text may require manual input or web searching. This process may be time-consuming and inconvenient for users. The potential for quick and efficient translation of custom binary signatures or codes may be hindered. Real-time translation capabilities may not be available in conventional systems. Users may need to navigate to separate web-based conversion tools. Manual typing or copy-pasting of binary sequences may be necessary.

Existing mobile applications may not be specifically designed to interact with fashion items in a lightweight manner. Single-purpose functionality may not be a focus of conventional fashion-related applications. Brand-specific functionalities that enhance consumer engagement may be limited. The potential for creating unique product value through dedicated applications may not be fully realized. Complex, resource-intensive applications may not offer direct, real-time interaction with physical clothing items. Substantial data storage and processing power may be required for existing solutions.

In emergency situations, conventional identification methods may rely on physical documents or electronic devices. These items may be lost or damaged. Alternative forms of identification that are integrated into clothing items may not be readily available. Easy accessibility of identification information may not be provided by existing systems. Rapid identification in critical situations may be hindered. Physical cards or documents may need to be carried separately from everyday clothing.

Conventional OCR systems may be capable of recognizing and translating various types of text and characters. However, these systems may not be optimized for specialized codes or symbols, particularly in the context of fashion. The potential for creating unique and interactive experiences through clothing items may be restricted. OCR applications may struggle with accurately recognizing and translating codes in various lighting conditions. Different fabric textures may present challenges for recognition accuracy. Reliability in real-world fashion contexts may be limited.

The fashion industry may lack innovative ways to incorporate functional technology directly into clothing designs. This limitation may restrict the potential for creating multifunctional garments. Aesthetic appeal and practical utility may not be combined effectively in existing solutions. Wearable technology and interactive clothing elements may not be fully leveraged. Consumer interaction and brand loyalty in an increasingly digital marketplace may be reduced. Conventional brand engagement strategies may not exploit the potential of technology integration.

Existing methods for creating unique brand identities in the fashion industry may not fully exploit the potential of combining digital technology with physical products. Opportunities for differentiation and innovation in a competitive market may be missed. Data-driven functionalities into clothing items may be limited. Personalized consumer experiences may not be fully developed. Data collection for brand insights may be overlooked. Targeted marketing strategies and product improvements may be hindered.

Existing solutions for integrating technology with fashion may include smart fabrics with embedded sensors. QR codes for inventory tracking may be used. RFID tags for anti-theft purposes may be incorporated. However, these solutions may not provide a seamless and engaging experience for consumers interacting with their clothing. Smart fabrics may be expensive to produce. Specialized care may be required for smart fabric garments. Widespread adoption may be limited by cost and maintenance requirements. QR codes and RFID tags may serve primarily utilitarian purposes. Significant contribution to brand identity or consumer engagement may not be provided.

Some mobile applications may attempt to bridge the gap between fashion and technology. Virtual try-on experiences may be offered. Product information may be provided through these applications. However, these applications may be complex and resource-intensive. Direct, real-time interaction with physical clothing items may not be offered. Substantial data storage may be required. Processing power demands may not be ideal for quick, single-purpose interactions. User privacy concerns may arise from data collection practices.

The need for innovative solutions in the fashion industry that combine technology, brand identity, and practical functionality has become increasingly apparent. Current approaches to integrating digital elements with physical clothing items may be limited in their ability to create unique, interactive experiences for consumers. Existing identification methods incorporated into garments may not be readily accessible or easily interpretable in emergency situations. The potential for leveraging OCR technology in fashion contexts may be underutilized. Recognition and interpretation of specialized codes or symbols unique to specific brands may not be addressed. These limitations may hinder the development of multifunctional garments that could enhance consumer engagement, provide practical utility, and contribute to distinctive brand identities in the competitive fashion landscape.

Conventional OCR applications may be designed as general-purpose tools with broad functionality. These applications may require significant processing power and memory resources. Multi-featured OCR applications may include translation capabilities for numerous languages. Document scanning features may be incorporated into these applications. Cloud-based processing capabilities may be integrated into conventional OCR systems.

The resource requirements of conventional OCR applications may create limitations for single-purpose use cases. Large application file sizes may consume substantial storage space on mobile devices. Processing overhead may result in slower performance for simple translation tasks. Battery consumption may be increased due to complex processing algorithms. User interfaces may be cluttered with features unnecessary for specific translation functions.

Data storage practices in conventional OCR applications may raise privacy concerns. Translation history may be stored on mobile devices or cloud servers. User data may be collected for analytics purposes. Personal information may be transmitted to remote servers for processing. Stored data may be vulnerable to unauthorized access. User consent for data collection may not be clearly communicated.

The lack of specialized binary code recognition in existing OCR systems may create inefficiencies. Users may need to manually photograph binary sequences. Images may need to be uploaded to web-based conversion tools. Binary strings may require manual typing into converter interfaces. Copy-and-paste operations may be necessary to transfer binary data. Multiple application switches may be required to complete translation tasks.

Existing fashion technology integration methods may not create seamless user experiences. QR codes on garments may appear as afterthoughts rather than integrated design elements. NFC tags may require specific hardware capabilities not available on all mobile devices. RFID readers may not be accessible to average consumers. AR experiences may require downloading separate applications for each brand. Technology integration may compromise garment aesthetics.

The proprietary nature of existing fashion technology solutions may be limited. QR codes may be generated using publicly available tools. NFC technology may be implemented by any manufacturer. RFID systems may use standardized protocols. Brand differentiation through technology integration may be minimal. Competitive advantages from technology incorporation may be easily replicated.

Personalization capabilities in existing interactive apparel may be constrained. QR codes may link to generic brand websites rather than personalized content. NFC tags may provide product authentication but not individual customization. RFID systems may track inventory but not provide consumer-specific information. Unique identification through clothing may not be supported by existing technologies. Individual expression through technology-integrated fashion may be limited.

The visibility and discretion of existing identification methods may present challenges. Medical alert bracelets may be immediately visible to observers. Engraved information on jewelry may be readable by anyone in proximity. Lock screen medical information may be accessible to unauthorized individuals. Privacy protection for sensitive personal information may be inadequate. Social stigma associated with visible medical identification may discourage use.

Conventional identification systems may not integrate naturally with everyday fashion choices. Medical alert jewelry may conflict with personal style preferences. Separate identification cards may be forgotten or left behind. Electronic devices containing identification information may run out of battery power. Physical identification items may be damaged by water or physical impact. Fashion-conscious individuals may resist wearing traditional identification accessories.

The reliability of existing OCR systems for specialized code recognition may be inconsistent. Lighting conditions may significantly affect recognition accuracy. Fabric texture variations may interfere with character recognition. Curved surfaces on garments may distort code appearance. Wrinkles or folds in clothing may obscure portions of codes. Distance and angle of camera relative to code may impact recognition success.

Existing mobile applications for brand engagement may not provide direct interaction with physical products. Virtual try-on applications may simulate product appearance but not interact with actual garments. Product information applications may require manual product selection rather than automatic recognition. Loyalty program applications may function independently of product ownership. Real-time physical product interaction may not be supported by conventional brand applications.

The educational potential of binary code in fashion contexts may be unexplored. Binary code literacy may not be promoted through existing fashion products. Understanding of computer language fundamentals may not be encouraged by apparel design. Interactive learning opportunities through clothing may be absent. STEM education integration with fashion may be underdeveloped. Technology awareness through everyday items may not be leveraged.

Conventional approaches to emergency identification may assume availability of external items. First responders may need to search for identification cards in wallets or bags. Medical information may be stored on locked mobile devices. Emergency contacts may not be immediately accessible. Critical time may be lost locating identification information. Incapacitated individuals may be unable to direct responders to identification sources.

The scalability of existing fashion technology solutions may be limited. Custom NFC tag programming may require specialized equipment. RFID implementation may involve significant per-unit costs. Smart fabric production may not be economically viable for mass market products. Technology integration may increase manufacturing complexity. Cost barriers may prevent widespread adoption of interactive apparel.

Existing OCR applications may not provide exclusive functionality for specific brands. Generic translation tools may be used with any text or code. Brand-specific applications may not exist for fashion companies. Proprietary ecosystems linking apparel to dedicated software may be absent. Exclusive user experiences tied to specific clothing brands may not be available. Brand loyalty through technology integration may not be cultivated.

The authentication capabilities of existing fashion technology may be limited to anti-counterfeiting purposes. Consumer engagement beyond product verification may not be provided. Interactive experiences after purchase may not be supported. Ongoing brand interaction through owned products may be minimal. Post-sale customer relationships may not be enhanced by product technology. Long-term product value through interactive features may not be realized.

Conventional binary-to-ASCII conversion tools may exist only as web-based utilities. Mobile-optimized conversion applications may not be available. Offline conversion capabilities may require manual calculation methods. Real-time camera-based conversion may not be supported by existing tools. Integration with physical products displaying binary code may not be considered in tool design. User-friendly interfaces for quick conversion may be lacking.

The potential for creating unique brand identities through proprietary technology ecosystems may be underutilized in the fashion industry. Distinctive technological capabilities may not differentiate brands in competitive markets. Consumer perception of brand innovation may not be enhanced by technology integration. Market positioning through unique interactive experiences may not be pursued. Technological sophistication as a brand attribute may not be communicated through products.

Existing solutions may not address the convergence of multiple functional requirements in a single system. Emergency identification needs may be addressed separately from fashion considerations. Brand engagement may be pursued independently of practical utility. Technology integration may focus on single purposes rather than multifunctional capabilities. Comprehensive solutions combining aesthetic design, brand identity, practical functionality, and emergency utility may not be available. The fashion industry may lack integrated approaches to technology incorporation that serve multiple stakeholder needs simultaneously.

There is a need for solutions that address the convergence of multiple functional requirements in a single integrated system. Emergency identification needs may require immediate accessibility without reliance on separate physical items. Brand engagement may benefit from proprietary technological ecosystems that create distinctive consumer experiences. Practical utility may be enhanced through seamless integration of functional capabilities into everyday apparel. Aesthetic design considerations may need to be balanced with technological functionality. These diverse requirements may not be adequately addressed by existing solutions that focus on single-purpose implementations. The fashion industry may lack comprehensive approaches that simultaneously serve aesthetic, branding, identification, and emergency utility purposes. Consumer expectations for technology integration in apparel may be evolving beyond simple QR codes or RFID tags. The potential for creating multifunctional garments that combine visual design with machine-readable information may remain largely unexplored. Existing OCR applications may not be optimized for the specific requirements of fashion-integrated binary code recognition. The opportunity to create lightweight, dedicated mobile applications that interact exclusively with branded apparel may not be fully realized. Privacy-preserving identification methods that maintain discretion while enabling emergency access may be lacking in current wearable technology solutions.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A method may be provided for real-time binary-to-ASCII translation from encoded garments using a mobile device. The method may comprise receiving, by a mobile application executing on the mobile device, user input to activate a scanning mode. The method may comprise activating, by the mobile application, a camera of the mobile device. The method may comprise capturing, by the camera, image data of a binary code pattern displayed on a custom garment. The method may comprise processing, by the mobile application, the captured image data using optical character recognition to identify individual binary digits within the binary code pattern. The method may comprise converting, by the mobile application, the identified binary digits to ASCII text using a binary-to-ASCII conversion algorithm. The method may comprise displaying, by the mobile application, the ASCII text on a display of the mobile device in real-time.

The method may further comprise continuously repeating the capturing, processing, converting, and displaying steps to provide real-time translation updates as the camera moves relative to the custom garment. The binary code pattern may comprise a unique identifier associated with a specific user. The ASCII text may comprise identification information for the specific user. Converting the identified binary digits to ASCII text may comprise accessing a binary-to-ASCII lookup table stored in memory of the mobile device. Converting may comprise mapping each group of binary digits to corresponding ASCII characters using the lookup table. Converting may comprise assembling the ASCII characters into the ASCII text. The method may further comprise verifying, by the mobile application, that the binary code pattern conforms to an authorized format before performing the converting and displaying steps. The custom garment may comprise a hooded sweatshirt having the binary code pattern printed on a visible surface.

A system may be provided for translating binary code patterns on garments to ASCII text. The system may comprise a custom garment displaying a unique binary code pattern. The system may comprise a mobile computing device. The mobile computing device may comprise a camera configured to capture image data. The mobile computing device may comprise a display. The mobile computing device may comprise a processor. The mobile computing device may comprise memory storing instructions that, when executed by the processor, cause the mobile computing device to activate the camera in response to user input. The instructions may cause the mobile computing device to capture image data of the binary code pattern on the custom garment. The instructions may cause the mobile computing device to process the captured image data using optical character recognition to identify binary digits within the binary code pattern. The instructions may cause the mobile computing device to convert the identified binary digits to ASCII text using a conversion algorithm. The instructions may cause the mobile computing device to display the ASCII text on the display in real-time.

The memory may further store instructions that, when executed by the processor, cause the mobile computing device to continuously capture successive images of the binary code pattern. The instructions may cause the mobile computing device to process each successive image to identify binary digits. The instructions may cause the mobile computing device to update the ASCII text based on the processed images. The instructions may cause the mobile computing device to refresh the display with updated ASCII text in real-time. The unique binary code pattern may encode identification information for a specific user. The memory may store a binary-to-ASCII conversion table. Converting the identified binary digits may comprise accessing the conversion table. Converting may comprise mapping groups of binary digits to ASCII characters using the conversion table. Converting may comprise assembling the ASCII characters into the ASCII text. The instructions may be configured to process binary code patterns exclusively from garments associated with a predetermined brand. The memory may further store instructions that, when executed by the processor, cause the mobile computing device to validate the binary code pattern against authorized pattern formats before performing conversion and display operations.

A method may be provided for providing user identification through binary-encoded garments. The method may comprise providing a garment having a binary code pattern that encodes user identification data. The method may comprise receiving, by a mobile application on a mobile device, activation input to initiate an identification process. The method may comprise activating, by the mobile application, a camera of the mobile device. The method may comprise capturing, by the camera, image data of the binary code pattern on the garment. The method may comprise processing, by the mobile application, the captured image data using pattern recognition to extract binary digit sequences from the binary code pattern. The method may comprise converting, by the mobile application, the extracted binary digit sequences to ASCII text. The method may comprise retrieving, by the mobile application, user identification information based on the ASCII text. The method may comprise displaying, by the mobile application, the user identification information on a screen of the mobile device.

The user identification information may comprise at least one of a name associated with the garment, contact information, and emergency contact data. The method may further comprise encrypting the user identification data within the binary code pattern during garment creation. The method may comprise decrypting the encrypted data after converting the binary digit sequences to ASCII text. The mobile application may be configured to process binary code patterns exclusively from authorized garments.

A non-transitory computer-readable medium may be provided storing instructions that, when executed by a processor of a mobile device, cause the mobile device to perform operations. The operations may comprise receiving user input to activate a binary code scanning application. The operations may comprise activating a camera of the mobile device. The operations may comprise capturing image data of a binary code pattern displayed on a garment. The operations may comprise processing the captured image data using optical character recognition to identify binary digits within the binary code pattern. The operations may comprise converting the identified binary digits to ASCII text using a binary-to-ASCII conversion process. The operations may comprise displaying the ASCII text on a display of the mobile device in real-time.

The operations may further comprise continuously repeating the capturing, processing, converting, and displaying operations to provide real-time translation as the camera position changes relative to the garment. The operations may further comprise accessing a conversion table stored in memory of the mobile device. The operations may comprise mapping binary digit groups to ASCII characters using the conversion table. The operations may comprise assembling the ASCII characters to generate the ASCII text.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 depicts a system architecture for real-time binary code translation on apparel, showing a mobile device, a garment, a blockchain, external services and data storage, and a network connecting the electronic elements.

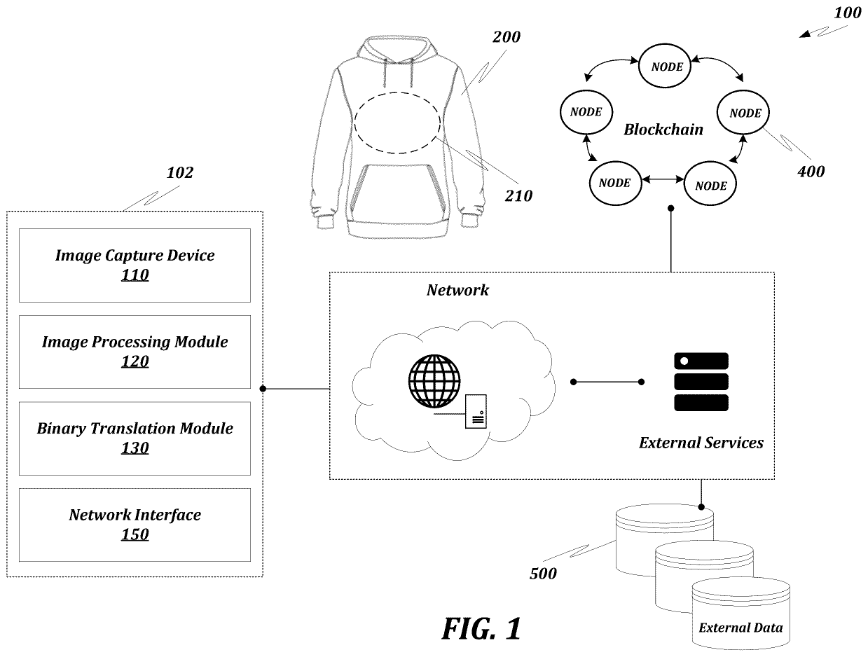

FIG. 2 illustrates a detailed block diagram of the mobile device of FIG. 1.

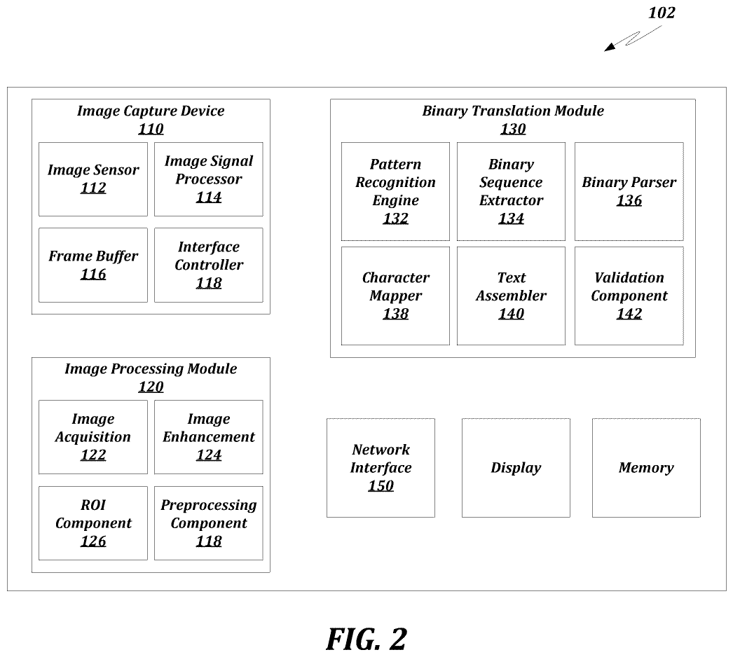

FIG. 3 presents a flowchart depicting a method for real-time binary code translation using the platform of FIG. 1.

FIG. 4 shows a back view of a hooded garment with a message indicating no valid binary code found.

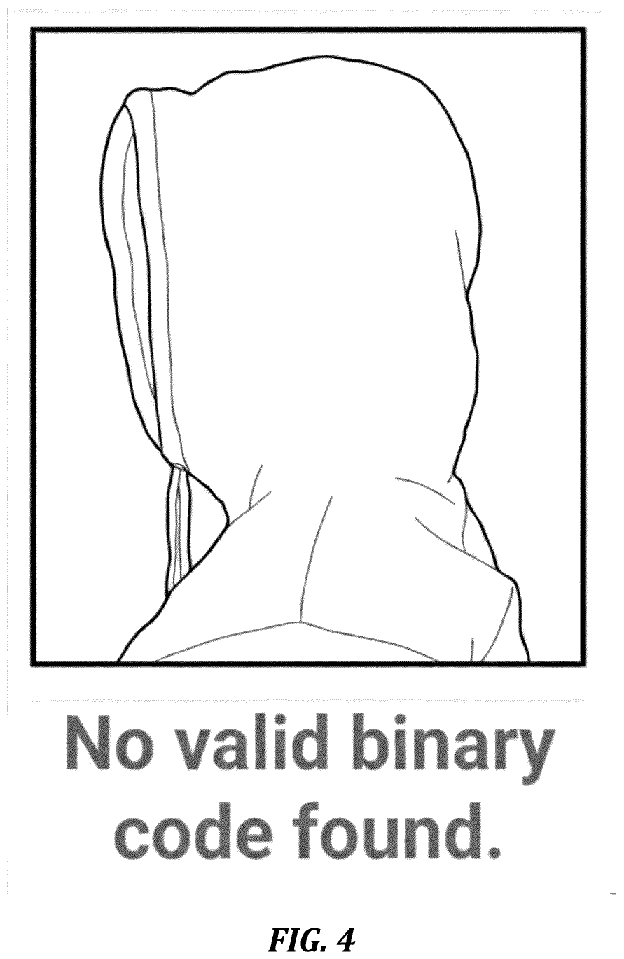

FIG. 5 illustrates a back view of a hooded garment displaying a binary code pattern comprising multiple rows of binary digits, along with a user interface panel showing the translated text output.

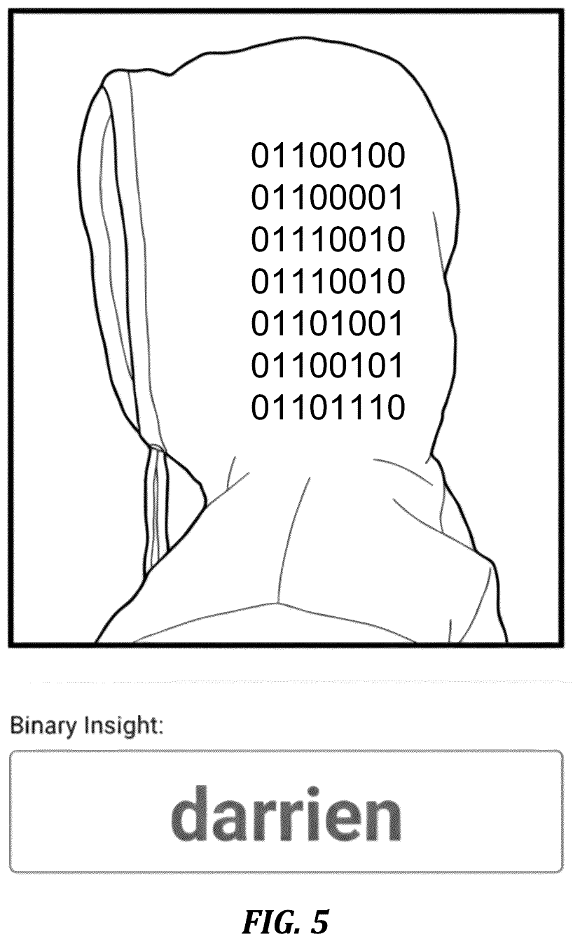

FIG. 6 depicts a block diagram of a computing device architecture used in performing the method of FIG. 3.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶ 6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure may address a technical problem of efficiently translating binary code displayed on custom garments to human-readable text in real-time using mobile devices. This problem may arise in various scenarios where quick identification or information retrieval from binary-coded garments is desired.

For example, in some embodiments, a custom garment, such as a hooded sweatshirt or other wearable may be provided with a unique binary code design. Users may need or want to rapidly translate the binary code to obtain identification information associated with the wearer of the garment. The disclosed mobile application may provide a solution by enabling real-time capture and translation of binary code using a smartphone camera.

In one scenario, the mobile application may be used at large events or gatherings where multiple individuals are wearing custom binary-coded sweatshirts. The application may allow for quick identification and information retrieval by simply pointing a smartphone camera at the binary code on a person's sweatshirt. The translation may occur without requiring manual input of the binary digits. The user may simply aim the camera at the binary code design on the garment. The processor may execute instructions to automatically recognize the binary pattern within the captured image. The conversion to ASCII text may occur substantially instantaneously using the locally stored conversion table in memory.

Another example may involve emergency situations where traditional forms of identification are unavailable. The binary code on a custom garment, when translated using the mobile application, may provide crucial identification and/or medical information about the wearer. In such scenarios, first responders or bystanders may use the mobile device to scan the binary code on an incapacitated person's garment. The application may display the wearer's name, emergency contact information, or medical conditions on the display. This information retrieval may occur rapidly, potentially within seconds of activating the camera. The offline functionality of the application may be particularly advantageous in emergency situations where network connectivity may be limited or unavailable.

The disclosed system and method may also find utility in brand authentication scenarios. Retailers or consumers may use the mobile application to verify the authenticity of custom garments by translating the binary code and confirming it matches authorized designs. The mobile application may access a database of authorized binary code patterns stored in memory. The processor may compare the recognized binary code from the captured image against the authorized patterns. If the binary code matches an authorized pattern, the application may display a verification message on the display. If the binary code does not match any authorized pattern, the application may display a warning indicating a potentially counterfeit garment. This verification process may help protect brand integrity and prevent unauthorized reproduction of custom garments.

In educational settings, the system may be used as an interactive tool for teaching binary code concepts. Students wearing custom binary-coded garments may use the mobile application to translate and learn about binary-to-text conversion in a hands-on manner. Teachers may provide students with garments displaying various binary code designs. Students may use mobile devices to scan the binary codes and observe the real-time translation to ASCII text on the display. This interactive approach may help students understand the relationship between binary representation and human-readable text. Students may also learn about the underlying conversion process by examining how the processor accesses the conversion table in memory to map binary sequences to ASCII characters.

These examples illustrate how the disclosed invention may address the technical problem of real-time binary code translation in various practical scenarios involving custom garments. The mobile application's ability to quickly capture, process, and display translated information may provide an efficient solution across multiple use cases. The system may operate without requiring network connectivity through the network interface 150, enabling functionality in areas with limited or no wireless coverage. The lightweight design of the application may minimize storage requirements in memory while maintaining rapid processing capabilities through the processor.

The translation may occur without requiring manual input of the binary digits. The user may simply aim the camera at the binary code design on the garment. The processor may execute instructions to automatically recognize the binary pattern within the captured image. The conversion to ASCII text may occur substantially instantaneously using the locally stored conversion table in memory.

Another example may involve emergency situations where traditional forms of identification are unavailable. The binary code on a custom garment, when translated using the mobile application, may provide crucial identification and/or medical information about the wearer. In such scenarios, first responders or bystanders may use the mobile device to scan the binary code on an incapacitated person's garment. The application may display the wearer's name, emergency contact information, or medical conditions on the display. This information retrieval may occur rapidly, potentially within seconds of activating the camera. The offline functionality of the application may be particularly advantageous in emergency situations where network connectivity may be limited or unavailable.

The disclosed system and method may also find utility in brand authentication scenarios. Retailers or consumers may use the mobile application to verify the authenticity of custom garments by translating the binary code and confirming it matches authorized designs. The mobile application may access a database of authorized binary code patterns stored in memory. The processor may compare the recognized binary code from the captured image against the authorized patterns. If the binary code matches an authorized pattern, the application may display a verification message on the display. If the binary code does not match any authorized pattern, the application may display a warning indicating a potentially counterfeit garment. This verification process may help protect brand integrity and prevent unauthorized reproduction of custom garments.

In educational settings, the system may be used as an interactive tool for teaching binary code concepts. Students wearing custom binary-coded garments may use the mobile application to translate and learn about binary-to-text conversion in a hands-on manner. Teachers may provide students with garments displaying various binary code designs. Students may use mobile devices to scan the binary codes and observe the real-time translation to ASCII text on the display. This interactive approach may help students understand the relationship between binary representation and human-readable text. Students may also learn about the underlying conversion process by examining how the processor accesses the conversion table in memory to map binary sequences to ASCII characters.

The system may further be employed in social networking contexts where individuals wearing binary-coded garments can share encoded messages or personal identifiers. At conventions, meetups, or other social gatherings, attendees may scan each other's garments to reveal usernames, social media handles, or custom messages. The mobile application may facilitate these interactions by providing quick translation without requiring verbal exchange of information. The binary code design on the garment may serve as both a fashion statement and a functional communication tool. Users may customize their garments with binary codes encoding their preferred online identities or personalized messages.

In retail environments, the system may enable enhanced customer engagement through interactive product experiences. Customers may use the mobile application to scan binary codes on display garments to access product information, pricing details, or promotional content. The binary code may encode URLs or product identifiers that the application can process and display. Retailers may leverage this technology to provide additional product context without cluttering physical displays with excessive signage. The system may also facilitate inventory management by allowing staff to quickly scan garments and retrieve stock information or product specifications.

The disclosed solution may also be applied in access control scenarios. Organizations may issue garments with binary codes encoding access credentials or membership information. Security personnel may use the mobile application to verify authorization by scanning the binary code on a person's garment. The application may decode the binary pattern and display the individual's access level or membership status. This approach may provide a visible yet encoded form of identification that can be quickly verified without requiring physical badges or cards.

In gaming and entertainment contexts, the system may enable augmented reality experiences tied to physical garments. Players wearing binary-coded garments may use the mobile application to unlock in-game content, reveal character information, or access special features. The binary code may encode unique identifiers that the application recognizes and uses to trigger specific digital content. This integration of physical apparel with digital experiences may create novel forms of interactive entertainment.

The system may be utilized in healthcare settings where patients wear garments with binary codes encoding medical information. Healthcare providers may use the mobile application to quickly access patient data, allergy information, or medication lists by scanning the binary code on a patient's garment. This may be particularly useful in emergency departments or situations where electronic medical records are not immediately accessible. The binary encoding may provide a layer of privacy by making the information not immediately readable to casual observers while remaining quickly accessible to authorized personnel with the translation application.

In logistics and supply chain management, the system may facilitate tracking of textile products through manufacturing and distribution processes. Workers may scan binary codes on garments to record processing stages, quality control checkpoints, or shipping information. The mobile application may translate the binary code and interface with inventory management systems to update product status. This may provide an alternative or supplement to traditional barcode or RFID tracking methods.

The disclosed solution may also support artistic and creative applications where designers incorporate binary code as a visual design element with functional meaning. Fashion designers may create garments where the binary pattern serves both aesthetic and communicative purposes. Wearers may reveal hidden messages or artistic statements encoded in the binary design by using the mobile application. This fusion of form and function may enable new modes of expression in fashion design.

In corporate or organizational settings, the system may facilitate team identification and networking. Employees or members may wear garments with binary codes encoding their names, departments, or roles. Colleagues may use the mobile application to quickly identify and learn about team members, particularly in large organizations or at corporate events. The binary code may provide a modern and technologically integrated alternative to traditional name badges.

The system may be adapted for use in tourism and cultural contexts where visitors wear garments with binary codes encoding information about attractions, tours, or cultural sites. Tour guides or information kiosks may provide garments to visitors, who can then use the mobile application to access relevant information by scanning the binary code. This may create an interactive and personalized tourism experience.

In fitness and sports contexts, athletes may wear garments with binary codes encoding performance data, training information, or team affiliations. Coaches or trainers may use the mobile application to quickly access athlete information during training sessions or competitions. The binary code may provide a convenient way to associate physical identification with digital performance tracking systems.

The disclosed system and method may provide a versatile platform for encoding and decoding information on garments across numerous application domains. The combination of physical binary code designs on apparel with mobile optical character recognition technology may enable rapid, offline translation of encoded information into human-readable text. This approach may offer advantages in scenarios requiring quick information access, privacy-preserving identification, brand authentication, or interactive experiences tied to physical garments.

The present disclosure includes many aspects and features. Moreover, while many aspects and features relate to, and are described in, the context of a binary code translation platform, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The system may enable users to interact with binary-coded garments in various social and practical contexts. At events or gatherings where individuals wear custom garments displaying binary code designs, other attendees may use the mobile application to quickly identify wearers or access encoded messages. The translation may occur without requiring verbal exchange of information. The binary code design on the garment may serve as both a fashion statement and a functional communication tool.

In retail environments, the system may facilitate customer engagement through interactive product experiences. Customers may use the mobile application to scan binary codes on display garments to access product information or promotional content. The binary code may encode identifiers that the application can process and display. Retailers may leverage this technology to provide additional product context without cluttering physical displays with excessive signage.

The disclosed solution may be applied in access control scenarios. Organizations may issue garments with binary codes encoding access credentials or membership information. Security personnel may use the mobile application to verify authorization by scanning the binary code on a person's garment. The application may decode the binary pattern and display the individual's access level or membership status. This approach may provide a visible yet encoded form of identification that can be quickly verified without requiring physical badges or cards.

In gaming and entertainment contexts, the system may enable experiences tied to physical garments. Players wearing binary-coded garments may use the mobile application to unlock content or access features. The binary code may encode unique identifiers that the application recognizes and uses to trigger specific digital content. This integration of physical apparel with digital experiences may create forms of interactive entertainment.

The system may be utilized in healthcare settings where patients wear garments with binary codes encoding medical information. Healthcare providers may use the mobile application to quickly access patient data or medication lists by scanning the binary code on a patient's garment. This may be useful in emergency departments or situations where electronic medical records are not immediately accessible. The binary encoding may provide a layer of privacy by making the information not immediately readable to casual observers while remaining quickly accessible to authorized personnel with the translation application.

In logistics and supply chain management, the system may facilitate tracking of textile products through manufacturing and distribution processes. Workers may scan binary codes on garments to record processing stages or shipping information. The mobile application may translate the binary code and interface with inventory management systems to update product status. This may provide an alternative or supplement to traditional barcode or RFID tracking methods.

The disclosed solution may support artistic and creative applications where designers incorporate binary code as a visual design element with functional meaning. Fashion designers may create garments where the binary pattern serves both aesthetic and communicative purposes. Wearers may reveal hidden messages or artistic statements encoded in the binary design by using the mobile application. This fusion of form and function may enable new modes of expression in fashion design.

In corporate or organizational settings, the system may facilitate team identification and networking. Employees or members may wear garments with binary codes encoding their names, departments, or roles. Colleagues may use the mobile application to quickly identify and learn about team members, particularly in large organizations or at corporate events. The binary code may provide an alternative to traditional name badges.

The system may be adapted for use in tourism and cultural contexts where visitors wear garments with binary codes encoding information about attractions or tours. Tour guides or information kiosks may provide garments to visitors, who can then use the mobile application to access relevant information by scanning the binary code. This may create an interactive and personalized tourism experience.

In fitness and sports contexts, athletes may wear garments with binary codes encoding performance data or team affiliations. Coaches or trainers may use the mobile application to quickly access athlete information during training sessions or competitions. The binary code may provide a convenient way to associate physical identification with digital performance tracking systems.

The disclosed system and method may provide a platform for encoding and decoding information on garments across numerous application domains. The combination of physical binary code designs on apparel with mobile optical character recognition technology may enable rapid, offline translation of encoded information into human-readable text. This approach may offer advantages in scenarios requiring quick information access, privacy-preserving identification, brand authentication, or interactive experiences tied to physical garments.

Embodiments of the present disclosure may comprise methods, systems, and a computer readable medium comprising, but not limited to, at least one of the following:
A. A Garment
B. An Image Capture Device
C. An Image Processing Module
D. A Binary Translation Module

In some embodiments, the present disclosure may provide an additional set of modules for further facilitating the software and hardware platform. The additional set of modules may comprise, but not be limited to:
E. A Network Interface
F. A Blockchain Receipt Module
G. A Virtual Garment

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 600 may be employed in the performance of some or all of the stages disclosed with regard to the methods. Similarly, an apparatus may be employed in the performance of some or all of the stages of the methods. As such, the apparatus may comprise at least those architectural components as found in computing device 600.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
receiving, by a mobile application executing on the mobile device, user input to activate a scanning mode;
activating, by the mobile application, a camera of the mobile device;
capturing, by the camera, image data of a binary code pattern displayed on a custom garment;
processing, by the mobile application, the captured image data using optical character recognition to identify individual binary digits within the binary code pattern;
converting, by the mobile application, the identified binary digits to ASCII text using a binary-to-ASCII conversion algorithm; and
displaying, by the mobile application, the ASCII text on a display of the mobile device in real-time.

Although the aforementioned method has been described to be performed by the platform 100, it should be understood that computing device 600 may be used to perform the various stages of the method. Furthermore, in some embodiments, different operations may be performed by different networked elements in operative communication with computing device 600. For example, a plurality of computing devices may be employed in the performance of some or all of the stages in the aforementioned method. Moreover, a plurality of computing devices may be configured much like a single computing device 600. Similarly, an apparatus may be employed in the performance of some or all stages in the method. The apparatus may also be configured much like computing device 600.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

The system may enable users to interact with binary-coded garments through a mobile application that performs real-time optical character recognition and translation. The mobile device may capture visual images of binary code patterns displayed on custom garments and convert these patterns into human-readable ASCII text without requiring manual input or network connectivity. The application may operate as a lightweight, single-purpose tool that stores no user data and performs all processing locally on the mobile device.

The custom garments may display binary code designs that encode various types of information, including identification data, emergency contact information, brand authentication codes, or personalized messages. The binary code may be applied to the garment through durable printing, embroidery, or other permanent application methods that maintain readability through regular wear and washing. The code may be strategically positioned on visible areas of the garment to facilitate easy scanning by mobile device cameras.

The mobile application may utilize the device's camera to capture images of the binary code displayed on garments. The processor may execute optical character recognition algorithms specifically optimized for recognizing binary patterns. The application may process captured images through enhancement techniques including noise reduction, contrast adjustment, and edge detection to improve recognition accuracy. The recognized binary sequences may be converted to ASCII text using conversion tables stored locally in the device's memory.

The translation process may occur in real-time as the camera captures continuous frames of the binary code. The display may be updated substantially instantaneously with the converted ASCII text as new portions of the binary code enter the camera's field of view. This continuous operation may enable users to scan larger binary code patterns or multiple codes on a single garment without interruption. The application may provide visual feedback to indicate successful code recognition and translation completion.

The system may incorporate verification mechanisms to ensure that only valid binary codes from authorized garments are processed and translated. The application may check captured binary patterns against databases of authorized codes or validate digital signatures embedded within the code design. This verification may help prevent misuse and ensure the application processes only legitimate binary codes from authorized custom garments. Invalid or unrecognized codes may trigger warning messages or prevent display of translated text.

The mobile device may include standard smartphone components including a processor, memory, display, camera, and optional network interface. The processor may execute instructions stored in memory to perform binary code translation functions. The memory may store the mobile application, binary-to-ASCII conversion tables, and temporary data needed for operation. The display may present translated ASCII text and user interface elements to the user. The camera may capture high-resolution images of binary code patterns with autofocus and image stabilization capabilities.

The application may be designed to operate without requiring active network connectivity for core translation functionality. All necessary data and processing capabilities may be contained within the mobile device itself, enabling offline operation. This offline capability may be particularly advantageous in scenarios with limited connectivity, such as large events, remote locations, or emergency situations where network infrastructure may be unavailable or overloaded. Optional network features may include user authentication, data synchronization, or accessing external databases for enhanced functionality.

The operating environment for enabling the technical solution of the disclosure may comprise multiple interconnected components working in concert to facilitate real-time binary code translation from custom garments. The environment may span physical, digital, and network domains to support the full range of functionality described herein.

The physical environment may include spaces where custom garments bearing binary code designs are manufactured, distributed, worn, and scanned. Manufacturing facilities may provide controlled conditions for applying binary code patterns to fabric surfaces through various methods including screen printing, digital printing, embroidery, or heat transfer. These facilities may maintain quality control stations where binary code readability may be verified before garments are released for distribution. The manufacturing environment may include equipment for generating unique binary sequences, converting ASCII text to binary representation, and creating visual designs that optimize optical recognition while maintaining aesthetic appeal.

Retail environments may serve as points of distribution where custom garments are presented to consumers. These spaces may include physical storefronts, pop-up shops, convention booths, or online retail platforms. Physical retail locations may provide demonstration areas where potential customers can observe the binary translation functionality in action. Sales personnel may use mobile devices running the translation application to showcase how binary codes on display garments can be scanned and translated. Point-of-sale systems in retail environments may integrate with blockchain networks to generate NFT receipts upon garment purchase.

Consumer environments may encompass the diverse settings where individuals wear custom garments and where others may scan the binary codes displayed thereon. These environments may include indoor spaces such as homes, offices, schools, convention centers, and retail establishments. Outdoor environments may include streets, parks, event venues, and public gathering spaces. The consumer environment may present varying lighting conditions ranging from bright sunlight to dim indoor illumination. Ambient light sources may include natural daylight, incandescent bulbs, fluorescent tubes, LED fixtures, and mixed lighting scenarios. The translation system may function across this spectrum of lighting conditions through automatic camera adjustment and image processing optimization.

The physical distance between the mobile device camera and the garment may vary based on the scanning scenario. Typical scanning distances may range from several inches to several feet depending on the size of the binary code design and the camera capabilities of the mobile device. The environment may accommodate both stationary scanning where the device and garment remain relatively fixed, and dynamic scanning where either or both may be in motion. Movement may introduce challenges such as motion blur, changing perspective angles, and varying focal distances that the system may address through continuous autofocus, image stabilization, and rapid frame processing.

Social environments where the technology may be deployed may include gatherings, events, conventions, meetups, and other scenarios where multiple individuals wearing binary-coded garments may congregate. These settings may facilitate peer-to-peer identification and information exchange through garment scanning. The environment may support both one-to-one interactions where a single user scans a single garment, and one-to-many scenarios where a user may scan multiple different garments in succession. The social environment may also include emergency response scenarios where first responders or bystanders may need to quickly identify an incapacitated individual through their garment.

The mobile computing environment may comprise the hardware and software ecosystem of smartphones and tablets that execute the translation application. This environment may include various mobile operating systems such as iOS, Android, and potentially others. The mobile environment may provide access to device cameras with varying specifications including different sensor resolutions, lens qualities, autofocus capabilities, and image stabilization technologies. Display technologies in the mobile environment may range from LCD to OLED panels with different sizes, resolutions, and color reproduction capabilities.

The mobile environment may include various sensors beyond the camera that may enhance the translation functionality. Ambient light sensors may detect environmental lighting conditions and trigger automatic camera adjustments. Accelerometers and gyroscopes may detect device orientation and movement, potentially optimizing capture timing or providing user feedback about device stability. GPS receivers may provide location data for optional location-based features. Proximity sensors may detect when the device is near a garment surface.

The software environment within mobile devices may include the operating system providing core services, the translation application itself, and potentially other applications running concurrently. The operating system may manage hardware resources, provide security controls, handle permissions for camera access, and facilitate inter-process communication. The translation application may operate within the constraints and capabilities provided by the operating system environment. Memory management within the mobile environment may allocate RAM for active processing while maintaining sufficient resources for other system functions.

The network environment, when present, may comprise wireless communication infrastructure that supports optional connectivity features. Cellular networks including 4G LTE and 5G may provide wide-area mobile data connectivity. Wi-Fi networks may offer local wireless connectivity in homes, offices, and public spaces. The network environment may include varying levels of signal strength, bandwidth availability, and connection stability. Some environments may provide robust high-speed connectivity while others may offer limited or intermittent network access. The core translation functionality may operate independently of network availability, while optional features may leverage network connectivity when available.

Blockchain network environments may provide distributed ledger infrastructure for recording NFT ownership and transaction data. These environments may include networks such as Ethereum, Solana, or other blockchain platforms. The blockchain environment may comprise distributed nodes that validate transactions, maintain consensus, and store immutable records. Smart contract execution environments within blockchain networks may process ownership transfers, royalty distributions, and other programmatic functions. The blockchain environment may interact with the mobile environment through network interfaces when NFT-related operations are performed.

Cloud computing environments may support optional backend services for the platform. Cloud infrastructure may host databases of authorized binary code patterns for authentication purposes. Cloud servers may provide user account management, preference synchronization, and application update distribution. The cloud environment may include data centers with redundant storage, load-balanced servers, and content delivery networks for efficient data distribution. Cloud services may be accessed through APIs that the mobile application may call when network connectivity is available.

Virtual environment platforms may provide digital spaces where virtual garments can be worn by avatars. Metaverse and multiverse platforms may offer three-dimensional worlds with physics simulation, social interaction, and digital asset management. The virtual environment may include rendering engines that display virtual garments on avatars, collision detection systems that prevent garments from intersecting with avatar bodies or environmental objects, and networking infrastructure that synchronizes virtual garment appearance across multiple users. Virtual platforms may support various file formats and asset standards for garment models, textures, and associated metadata.

Accordingly, embodiments of the present disclosure provide a software and hardware platform comprised of a distributed set of computing elements, including, but not limited to:

### A. A Garment

A garment 200 may comprise a wearable article of clothing configured to display a binary code design 210 in a manner that facilitates optical recognition by an image capture device 110 (e.g., a camera of a mobile device 102). The garment 200 may be manufactured from textile materials suitable for receiving and retaining visual markings. The textile materials may include natural fibers such as (but not limited to) cotton or wool. Additionally or alternatively, the textile materials may include synthetic fibers such as (but not limited to) polyester or nylon. The textile materials may include blended fabrics combining natural and synthetic fibers. The selection of textile materials may be based on factors including durability, comfort, washability, and suitability for receiving the binary code design 210.

The garment 200 may take various forms depending on the intended application and user preferences. In some embodiments, the garment 200 may comprise a hooded sweatshirt. The hooded sweatshirt may include a hood portion extending from the neckline. The hooded sweatshirt may include long sleeves. The hooded sweatshirt may include a front pocket region. In other embodiments, the garment 200 may comprise a t-shirt, a jacket, or any other article of clothing intended to cover a wearer's torso. In additional embodiments, the garment 200 may comprise a hat or cap. The garment 200 may comprise other wearable articles including but not limited to pants, shorts, scarves, gloves, or other accessories.

The binary code design 210 may be applied to the garment 200 through various manufacturing techniques. In some embodiments, the binary code design 210 may be applied through screen printing. Screen printing may involve forcing ink through a mesh screen onto the fabric surface. The mesh screen may have areas blocked off to create the desired pattern. In other embodiments, the binary code design 210 may be applied through digital printing. Digital printing may involve directly applying ink to the fabric using inkjet or similar technology. Digital printing may allow for high-resolution reproduction of the binary code design 210. In further embodiments, the binary code design 210 may be applied through embroidery. Embroidery may involve stitching thread into the fabric to create the binary code pattern. Embroidered designs may provide enhanced durability and tactile texture. In additional embodiments, the binary code design 210 may be applied through heat transfer. Heat transfer may involve applying a pre-printed design to the fabric using heat and pressure. The binary code design 210 may be applied through other techniques including but not limited to sublimation printing, appliqué, or weaving.

The binary code design 210 may be positioned on the garment 200 in one or more locations that optimize or enhance visibility and/or scanability. In embodiments where the garment 200 comprises a hooded sweatshirt, the binary code design 210 may be positioned on the back panel of the sweatshirt, the chest area of the sweatshirt, the hood portion of the sweatshirt, the sleeves of the sweatshirt, and/or the like. Multiple instances of the binary code design 210 may be positioned at different locations on the garment 200.

The binary code design 210 may be configured with visual characteristics that facilitate accurate optical recognition by the camera 140. The binary code design 210 may utilize high contrast between the binary digits and the background fabric. High contrast may be achieved through color selection, reflectivity, and/or the like. In some embodiments, the binary code design 210 may comprise black digits on a white or light-colored background. In other embodiments, the binary code design 210 may comprise white digits on a black or dark-colored background. The contrast ratio may be selected to exceed a threshold value that helps to ensure reliable recognition under various lighting conditions.

The size of the binary digits in the binary code design 210 may be selected to balance visibility and aesthetic considerations. As non-limiting examples, the height of individual binary digits may range from approximately five millimeters to approximately twenty millimeters. Larger digit sizes may facilitate recognition from greater distances. Smaller digit sizes may allow for more compact designs. The width of individual binary digits may be proportional to the height. The spacing between adjacent binary digits may be selected to prevent visual merging while maintaining a cohesive appearance. As examples, the spacing may range from approximately one millimeter to approximately five millimeters.

The binary code design 210 may be arranged in various patterns on the garment 200. In some embodiments, the binary code design 210 may be arranged in horizontal rows. Each row may contain a fixed number of binary digits. The rows may be stacked vertically with consistent spacing between rows. In other embodiments, the binary code design 210 may be arranged in vertical columns. Each column may contain a sequence of binary digits. The columns may be positioned side by side with consistent spacing between columns. In further embodiments, the binary code design 210 may be arranged in a grid pattern. The grid pattern may include both horizontal and vertical alignment of binary digits. In additional embodiments, the binary code design 210 may be arranged in a circular or curved pattern. The pattern may follow the contours of the garment 200.

The binary code design 210 may encode various types of information. In some embodiments, the binary code design 210 may encode identification information associated with a specific wearer. The identification information may include the wearer's name, a username or nickname (e.g., a username associated with online gaming platform(s), social media account(s), and/or other virtual communities), contact information. The contact information (e.g., telephone numbers, email addresses, physical addresses, etc.), and/or emergency contact information (e.g., names and contact details for individuals to be notified in case of emergency). The identification information may be encoded in ASCII or Unicode format and converted to binary representation.

In some embodiments, the binary code design 210 may encode medical information associated with the wearer. The medical information may include allergy information specifying one or more substances to which the wearer is allergic, information about chronic medical conditions, medication information, blood type information, and/or the like.

In some embodiments, the binary code design 210 may encode brand authentication information. The brand authentication information may include a unique identifier assigned to the specific garment 200. The unique identifier may be used to verify that the garment 200 is an authentic product from an authorized manufacturer. The brand authentication information may include a serial number unique to the individual garment 200, manufacturing date information, a digital signature generated using cryptographic techniques to prevent counterfeiting, and/or the like.

In additional embodiments, the binary code design 210 may encode custom messages selected by the wearer. The custom messages may include personal statements, quotes, or artistic expressions. The custom messages may be selected during a garment customization process. The wearer may provide the desired message in text format (e.g., encoded in ASCII or Unicode). The message may be converted to binary representation for application to the garment 200.

The binary code design 210 may incorporate error correction features to enhance reliability of recognition and translation. In some embodiments, the binary code design 210 may include redundant encoding, such that if one portion of the design 210 becomes damaged or obscured, the redundant portion may still be readable. In other embodiments, the binary code design 210 may include checksum digits. Checksum digits may be calculated based on the encoded information. The mobile application may verify the checksum after recognition to detect errors. In further embodiments, the binary code design 210 may include error correction codes. Error correction codes may allow the mobile application to detect and correct certain types of errors in the recognized binary sequence.

The durability of the binary code design 210 may be enhanced through appropriate material selection and/or application techniques. The inks or threads used to create the binary code design 210 may be selected for resistance to fading. Fade resistance may be achieved through use of colorfast dyes or pigments. The binary code design 210 may be tested for wash resistance. Wash resistance testing may involve subjecting the garment 200 to multiple wash cycles. The binary code design 210 may remain clearly readable after a specified number of wash cycles. The binary code design 210 may be tested for abrasion resistance. Abrasion resistance testing may involve subjecting the garment 200 to simulated wear conditions. The binary code design 210 may maintain sufficient contrast and clarity after exposure to normal wear and friction.

The garment 200 may include additional design elements that complement the binary code design 210. The additional design elements may include decorative graphics. positioned around or adjacent to the binary code design 210. The decorative graphics may incorporate the brand identity of the manufacturer. The additional design elements may include text elements (e.g., brand name, slogans, and/or other messaging). The text elements may be positioned to frame or highlight the binary code design 210. The additional design elements may include color blocking. Color blocking may involve using different colored fabric panels or printed regions. The color blocking may create visual interest while maintaining the visibility of the binary code design 210.

The garment 200 may be manufactured in various sizes to accommodate different wearers. The binary code design 210 may be scaled proportionally for different garment sizes, such that larger garment sizes feature proportionally larger binary code designs 210, and smaller garment sizes may feature proportionally smaller binary code designs 210. The scaling may be designed to maintain the readability of the binary code design 210 across all sizes.

The garment 200 may be packaged with informational materials. The informational materials may include instructions for using a mobile application to translate the binary code design 210, download information for the mobile application, step-by-step guidance for scanning and translating the binary code design 210, information about the encoded content, and/or the like. The informational materials may include warranty information. The informational materials may include care instructions.

### B. An Image Capture Device

The image capture device 110 included in the mobile device 102 may comprise several hardware and/or software components working together to capture visual images of binary code patterns displayed on garments. The image capture device 110 may include an image sensor 112. The image sensor 112 may convert optical signals into electrical signals. The image sensor 112 may be, as examples, a CMOS sensor or a CCD sensor. The image sensor 112 may have a resolution sufficient to capture binary code patterns at typical viewing distances.

The image capture device 110 may include a lens assembly configured to focus light onto the image sensor 112. The lens assembly may include one or more optical elements (lens elements) arranged to provide appropriate focal length and field of view. The lens assembly may be configured to capture images at distances ranging from several inches to several feet from the binary code design 210.

The image capture device 110 may include an autofocus mechanism. The autofocus mechanism may automatically adjust the position of lens elements within the lens assembly. The autofocus mechanism may optimize focus based on the distance to the binary code design 210. The autofocus mechanism may employ phase detection and/or contrast detection techniques. The autofocus mechanism may operate continuously during image capture to maintain sharp focus as the mobile device 102 moves relative to the garment 200.

The image capture device 110 may include an image stabilization system. The image stabilization system may compensate for movement of the mobile device 102 during image capture. The image stabilization system may employ optical image stabilization techniques and/or electronic image stabilization techniques. The image stabilization system may reduce motion blur in captured images.

The image capture device 110 may include an exposure control system. The exposure control system may regulate the amount of light reaching the image sensor 112. The exposure control system may adjust exposure time. The exposure control system may adjust sensor sensitivity. The exposure control system may adjust aperture size in embodiments where the lens assembly includes a variable aperture.

The image capture device 110 may include a white balance adjustment system. The white balance adjustment system may correct color temperature variations in captured images. The white balance adjustment system may ensure that binary code patterns appear with accurate contrast regardless of ambient lighting conditions. The white balance adjustment system may operate automatically based on scene analysis.

The image capture device 110 may include an image signal processor 114. The image signal processor 114 may receive raw data from the image sensor 112. The image signal processor 114 may apply initial processing to the raw image data. The image signal processor 114 may perform noise reduction, color correction, edge enhancement, demosaicing, and/or the like. The image signal processor 114 may output processed image data to the image processing module 120 for further analysis.

The image capture device 110 may include a frame buffer 116. The frame buffer 116 may temporarily store captured image frames. The frame buffer 116 may allow the image processing module 120 to access image data for processing. The frame buffer 116 may support continuous capture of multiple frames per second during real-time translation operations.

The image capture device 110 may include a camera interface controller 118. The camera interface controller 118 may manage communication between the image capture device 110 and the image processing module 120. The camera interface controller 118 may receive control commands from the image processing module 120, and may transmit captured image data to the image processing module 120. The camera interface controller 118 may coordinate timing of image capture operations.

### C. An Image Processing Module

The image processing module 120 included in the mobile device 102 may comprise several hardware and/or software components working together to enable image enhancement. The image processing module 120 may include an image acquisition component 122. The image acquisition component 122 may receive raw image data from the camera 140. The image acquisition component 122 may buffer incoming image frames in temporary storage. The image acquisition component 122 may manage frame rate and resolution settings for optimal processing.

The image processing module 120 may include an image enhancement component 124. The image enhancement component 124 may apply noise reduction algorithms to captured images. The image enhancement component 124 may adjust contrast levels to improve binary code visibility. The image enhancement component 124 may perform edge detection to sharpen character boundaries. The image enhancement component 124 may correct perspective distortion when binary code is viewed at an angle.

The image processing module 120 may include a region of interest component 126. The region of interest component 126 may identify specific areas within images likely to contain binary codes. The region of interest component 126 may reduce processing load by focusing on relevant image regions. The region of interest component 126 may track code regions across multiple frames during continuous capture. The region of interest component 126 may adapt region boundaries as camera position changes.

The image processing module 120 may include a preprocessing component 128. The preprocessing component 128 may normalize image properties before pattern detection. The preprocessing component 128 may adjust brightness (e.g., based on ambient lighting conditions), apply white balance corrections, resize images to optimal dimensions for processing, adjust sharpness, clarity, and/or contrast, account for motion blur, and/or the like.

The image processing module 120 may include a quality assessment component that may evaluate image sharpness and clarity. The quality assessment component measure contrast levels in code regions. The quality assessment component may detect motion blur or focus issues. The quality assessment component may provide feedback to guide optimal camera positioning.

### D. A Binary Translation Module

The binary translation module 130 included in the mobile device 102 may comprise several hardware and/or software components working together to perform real-time binary code recognition and conversion. The binary translation module 130 may include a pattern recognition engine 132 configured to analyze processed image data to identify binary digit patterns within one or more captured frames. The pattern recognition engine 132 may distinguish binary code regions from background elements of the garment 200.

The binary translation module 130 may include a binary sequence extractor 134. The binary sequence extractor 134 may isolate individual binary digits from recognized patterns. The binary sequence extractor 134 may determine the spatial arrangement of digits within the binary code design 210. The binary sequence extractor 134 may concatenate individual digit recognitions into complete binary strings. The binary sequence extractor 134 may compare segmented characters against known binary digit templates. The binary sequence extractor 134 may calculate similarity scores for pattern matching. The binary sequence extractor 134 may distinguish between zeros and ones in various fonts and styles, and may handle variations in character appearance due to fabric texture or lighting. The binary sequence extractor 134 may order recognized digits according to spatial position, and may concatenate individual digit recognitions into complete binary strings. The binary sequence extractor 134 may validate sequence completeness and integrity, and may detect and flag incomplete or corrupted sequences.

The binary translation module 130 may include a binary parser 136. The binary parser 136 may segment continuous binary strings into fixed-length units. For example, the binary parser 136 may divide binary sequences into eight-bit bytes for ASCII and/or Unicode conversion. The binary parser 136 may validate the structure of extracted binary data. The binary parser 136 may isolate individual binary digits within detected code regions, determine spatial arrangement of the digits, separate overlapping or adjacent characters, and validate character boundaries for accuracy.

The binary translation module 130 may include a character mapper 138. The character mapper 138 may convert binary segments to decimal values. The character mapper 138 may map decimal values to corresponding ASCII or Unicode characters. The character mapper 138 may apply standard encoding tables during conversion.

The binary translation module 130 may include a text assembler 140. The text assembler 140 may concatenate individual characters into complete strings. The text assembler 140 may format translated text for display presentation. The text assembler 140 may generate human-readable output from binary input.

The binary translation module 130 may include a validation component 142. The validation component 142 may verify the integrity of recognized binary sequences. The validation component 142 may detect errors in pattern recognition. The validation component 142 may confirm successful conversion operations. In some embodiments, the validation component 142 may identify potential errors in extracted binary data. The validation component 142 may apply correction algorithms to damaged or incomplete sequences. The validation component 142 may improve translation accuracy under suboptimal conditions. The validation component 142 may identify potential recognition errors in extracted sequences, and apply error correction algorithms to improve accuracy. The validation component 142 may use redundancy or checksum data when available. In some embodiments, the validation component 142 may calculate reliability metrics for recognition results. The validation component 142 may assign confidence values to translated text. The validation component 142 may provide quality indicators to users.

The binary translation module 130 may optionally include a decryption component. The decryption component may process encrypted binary codes. The decryption component may apply decryption algorithms to secured data. The decryption component 14 may enable translation of protected information.

The binary translation module 130 may include a translation coordinator configured to manage the sequence of translation operations. The translation coordinator may coordinate data flow between module components, and may optimize processing efficiency.

The binary translation module 130 may be embodied as a real-time processor configured to enable continuous translation during live camera capture. The real-time processor may maintain low latency between capture and display, helping to facilitate fluid scanning experiences.

### E. A Network Interface

In some embodiments, a network interface 150 may be included in the mobile device 102 to enable optional connectivity features. The network interface 150 may include hardware and/or software components for transmitting and receiving data over wireless networks. The network interface 150 may support wireless communication protocols. The network interface 150 may comprise a cellular modem for connecting to mobile data networks. The cellular modem may support various generations of cellular technology including (but not limited to) 4G LTE and 5G standards. The network interface 150 may include a Wi-Fi adapter for connecting to wireless local area networks. The Wi-Fi adapter may support IEEE 802.11 standards including 802.11ac and 802.11ax protocols. The network interface 150 may incorporate Bluetooth circuitry for short-range wireless communication. The Bluetooth circuitry may support Bluetooth Low Energy protocols for power-efficient data exchange. The network interface 150 may include near-field communication hardware for contactless data transfer at very short ranges.

The network interface 150 may enable the mobile device 102 to communicate with external servers or databases when network connectivity is available. The network interface 150 may facilitate user authentication processes by transmitting credentials to remote authentication servers. The network interface 150 may allow the mobile application to verify the authenticity of binary code designs by querying remote databases of authorized patterns. The network interface 150 may support synchronization of user preferences and settings across multiple devices by communicating with cloud storage services. The network interface 150 may enable the mobile application to receive software updates and new binary pattern recognition algorithms from remote servers.

The network interface 150 may be utilized for optional blockchain-related operations. The network interface 150 may transmit transaction data to blockchain networks for recording NFT ownership information. The network interface 150 may receive blockchain data to verify the authenticity and ownership history of garments. The network interface 150 may facilitate communication with smart contracts deployed on blockchain platforms. The network interface 150 may enable the mobile device 102 to interact with distributed ledger systems for creating, transferring, or burning NFT receipts associated with physical garments.

The network interface 150 may support location-based services when GPS functionality is combined with network connectivity. The network interface 150 may transmit location data to enable features such as finding nearby retail locations for authorized custom garments. The network interface 150 may facilitate social sharing features by connecting to social media platforms when users opt to share translated binary messages. The network interface 150 may enable analytics and usage data collection by transmitting anonymized usage statistics to remote servers when users provide consent.

The network interface 150 may operate independently from the core binary code translation functionality. The mobile application may perform binary-to-ASCII conversion entirely on the mobile device 102 without requiring active network connectivity through the network interface 150. The network interface 150 may remain inactive during offline translation operations to conserve battery power. The network interface 150 may be selectively activated only when optional network-dependent features are requested by the user. The network interface 150 may automatically detect available network connections and select the most appropriate connection type based on signal strength and data requirements.

### F. A Blockchain Receipt Module

The blockchain receipt module 400 may comprise hardware and software components configured to create, manage, and verify blockchain-based ownership records for custom garments. The module 400 may interact with one or more distributed ledger networks to record non-fungible token (NFT) data representing receipts for physical garments. The blockchain receipt module 400 may be implemented using blockchain development frameworks and libraries appropriate for the chosen networks. The module 400 may utilize secure key management systems to handle cryptographic operations and protect private keys.

The blockchain receipt module 400 may support integration with multiple blockchain platforms. The module 400 may be configured to interact with Ethereum-based networks. The module 400 may be configured to interact with Solana-based networks. The module 400 may be configured to interact with other blockchain platforms depending on implementation requirements. This multi-chain support may allow for flexibility in choosing the most suitable blockchain for different types of NFTs. The multi-chain support may accommodate different user preferences for blockchain platforms.

The blockchain receipt module 400 may implement mechanisms to maintain consistency between off-chain databases and on-chain data. The module 400 may handle synchronization issues that may arise between different data sources. The module 400 may implement error handling routines to manage failed transactions. The module 400 may implement transaction monitoring capabilities to track pending blockchain operations. The module 400 may implement logging features to record blockchain-related activities for security purposes. The module 400 may implement auditing features to track blockchain-related activities for compliance purposes.

The blockchain receipt module 400 may record ownership data associated with NFTs representing custom garments. Responsive to an NFT being created, the blockchain receipt module 400 may record relevant data on the chosen blockchain network. Responsive to an NFT being transferred, the blockchain receipt module 400 may record relevant data on the chosen blockchain network. The recorded data may include NFT metadata. The NFT metadata may include a unique identifier for the NFT. The NFT metadata may include a creation date for the NFT. The NFT metadata may include details about the associated physical garment. The recorded data may include an NFT wallet address associated with a current owner. The recorded data may include transaction history information. The transaction history information may include previous owners of the NFT. The transaction history information may include sale prices for previous transfers. The transaction history information may include timestamps for previous transfers. The recorded data may include additional relevant information about the NFT or associated garment.

The blockchain receipt module 400 may create a virtual chain of custody for custom garments. The chain of custody may be recorded on the blockchain. The chain of custody may be immutable once recorded. The chain of custody may be publicly verifiable. The chain of custody may provide transparency regarding garment ownership history. The chain of custody may provide transparency regarding garment transaction history.

The blockchain receipt module 400 may be responsible for executing smart contracts. The module 400 may deploy smart contracts to and/or interact with smart contracts deployed on blockchain networks. The smart contracts may govern NFT transfers between parties and/or transfer of funds associated with NFT transactions. The smart contracts may be used to enforce predefined rules or conditions for NFT transfers. he smart contracts may distribute royalties to one or more parties based on transfer transactions, allow modification of royalty recipients, and/or allow modification of distribution percentages for royalties.

The blockchain receipt module 400 may validate ownership before executing transfers. Before executing a transfer, the blockchain receipt module 400 may retrieve ownership records from the blockchain, verify the ownership records, and validate that a seller has authority to transfer ownership of an NFT. The module 400 may validate that a seller has authority to transfer ownership of a garment associated with an NFT. The module 400 may ensure compliance with transfer restrictions encoded in smart contracts, which may be predefined, and may be specific to particular NFTs, particular brands, particular garment types, and/or particular garments.

The blockchain receipt module 400 may manage burning of NFTs during transfers. The blockchain receipt module 400 may manage minting of NFTs during transfers. To maintain privacy during ownership transfers, the module 400 may implement a process whereby an existing NFT is burned. Upon transfer of a garment, the NFT currently associated with the garment may be destroyed (burned) on the blockchain. A new NFT may be minted for a recipient of the garment. The new NFT may include updated ownership information corresponding to the recipient. This burn-and-mint process may help ensure that a previous owner can no longer claim ownership after transfer.

NFTs may be created through a minting process. At a high level, the minting process may entail creating a new block on the blockchain. The minting process may involve encrypting asset information, recording the encrypted asset information on a blockchain, validating NFT information (e.g., by a validator), and closing the new block after validation. The minting process may incorporate smart contracts. The smart contracts may assign ownership of the NFT and/or manage NFT transfers.

As tokens are minted, they may be assigned a unique identifier. The unique identifier may be directly linked to one blockchain address. Each token may have an owner. Ownership information may be publicly available on the blockchain. The ownership information may indicate an address in which the minted token resides. Even if multiple NFTs of the same exact item are minted, each token may have a unique identifier. Each token may be distinguished from other tokens based on the unique identifier.

The blockchain receipt module 400 may retrieve blockchain data to verify authenticity of NFTs. The blockchain receipt module 400 may retrieve blockchain data to verify ownership history of NFTs. The blockchain receipt module 400 may make retrieved information available to users. The blockchain receipt module 400 may make retrieved information available to applications. Users may verify authenticity and/or ownership history of custom garments using the retrieved information.

In some cases, blockchain transactions may incur fees. The blockchain receipt module 400 may manage payment of blockchain transaction fees. The blockchain receipt module 400 may automatically assign transaction fees to a requesting user. In some embodiments where multiple parties request a single transaction, the module 400 may allow users to choose one or more users responsible for payment of fees. The module 400 may allow users to split payment of fees among multiple parties.

The blockchain receipt module 400 may generate blockchain-based receipts for transactions involving custom garments. The receipts may be represented as NFTs on the blockchain. The receipts may provide proof of purchase. The receipts may provide proof of ownership. The receipts may provide proof of authenticity for custom garments. The blockchain-based receipts may be immutable once recorded. The blockchain-based receipts may be publicly verifiable. The blockchain-based receipts may be transferable between parties.

The blockchain receipt module 400 may implement robust error handling routines. The error handling routines may manage scenarios where blockchain transactions fail. The error handling routines may manage scenarios where network connectivity is lost during a transaction. The error handling routines may manage scenarios where insufficient funds are available for transaction fees. The module 400 may implement retry logic for failed transactions. The module 400 may implement notification mechanisms to alert users of transaction failures. The module 400 may implement notification mechanisms to alert users of transaction successes.

The blockchain receipt module 400 may include transaction monitoring capabilities. The module 400 may track pending transactions until confirmation. The module 400 may monitor transaction status on the blockchain network. The module 400 may provide real-time updates to users regarding transaction progress. The module 400 may provide notifications when transactions are confirmed. The module 400 may provide notifications when transactions are rejected.

The blockchain receipt module 400 may maintain a local cache of blockchain data. The local cache may improve performance by reducing the need for repeated blockchain queries. The local cache may be synchronized with the blockchain periodically. The local cache may be synchronized with the blockchain in response to specific events. The module 400 may implement cache invalidation mechanisms to ensure data consistency. The module 400 may implement cache update mechanisms to ensure data accuracy.

The blockchain receipt module 400 may support encrypted storage of NFT metadata. The metadata may be encrypted using public key cryptography, such as (but not limited to) using the public key of an NFT owner. When NFT data is retrieved, a user private key may be used to decrypt the metadata. The platform itself may serve as a means of authentication through this encryption mechanism. This encryption approach may provide an additional layer of security for sensitive information. This encryption approach may provide privacy protection for NFT owners.

The blockchain receipt module 400 may support royalty distribution mechanisms. When an NFT is transferred, the module 400 may calculate royalty payments. The module 400 may distribute royalty payments to designated recipients. The royalty recipients may include original creators of garments, brand owners, and/or other stakeholders. The royalty distribution may be automated through smart contracts. The royalty recipients and/or percentages may be configurable.

The blockchain receipt module 400 may maintain an audit trail of all blockchain operations. The audit trail may record all NFT creation, mint, transfer and burn events. The audit trail may include timestamps, user identifiers, and transaction identifiers for each operation. The audit trail may be stored securely. The audit trail may be accessible for compliance and/or dispute resolution purposes.

By leveraging blockchain technology, the blockchain receipt module 400 may help ensure security of ownership records for custom garments. The module 400 may help ensure transparency of ownership records. The module 400 may help ensure immutability of ownership records. This may enable novel use cases around garment authentication. This may enable novel use cases around resale markets for custom garments. This may enable novel use cases around integration with virtual environments. The blockchain-based approach may provide advantages over traditional centralized databases for tracking ownership. The blockchain-based approach may provide verifiable proof of authenticity. The blockchain-based approach may provide verifiable proof of provenance for custom garments.

### G. A Virtual Garment

The virtual garment 500 may comprise a digital representation of the physical garment 200. The virtual garment 500 may be configured for use in virtual environments. The virtual garment 500 may be rendered as a three-dimensional model, including geometric data defining the shape and structure of the garment. The geometric data may comprise polygonal meshes that define surfaces of the virtual garment 500.

The virtual garment 500 may include texture mapping data that may replicate the visual appearance of the physical garment 200, including representations of the binary code design 210. The binary code design 210 on the virtual garment 500 may be visually identical to the binary code design 210 on the physical garment 200. The binary code design 210 on the virtual garment 500 may encode the same information as the binary code design 210 on the physical garment 200.

The virtual garment 500 may be configured for display in metaverse environments and/or multiverse environments. The virtual garment 500 may be wearable by digital avatars representing users in virtual spaces. The virtual garment 500 may be rendered on the digital avatars in real-time, as the digital avatars move within the virtual environments.

The virtual garment 500 may include physics simulation properties that govern how the virtual garment 500 behaves in response to virtual forces (e.g., simulated gravity, simulated wind, avatar movement, etc.). The physics simulation properties may cause the virtual garment 500 to drape realistically on the digital avatar. The physics simulation properties may cause the virtual garment 500 to move in response to avatar motion.

The virtual garment 500 may be associated with metadata. The metadata may link the virtual garment 500 to the physical garment 200. The metadata may include a unique identifier corresponding to the unique identifier of the physical garment 200. The metadata may include ownership information (e.g., the current owner of both the virtual garment 500 and the physical garment 200). The metadata may be stored on a blockchain network. The blockchain network may be the same network used by the blockchain receipt module 400.

The virtual garment 500 may be transferable between users. The transfer of the virtual garment 500 may be recorded on the blockchain network. The transfer of the virtual garment 500 may occur simultaneously with the transfer of the physical garment 200, or independently of transfer of the physical garment 200. The transfer may be governed by smart contracts. The smart contracts may enforce rules regarding ownership and transfer rights.

The virtual garment 500 may be compatible with multiple virtual platforms. The virtual garment 500 may be exported in various file formats, including formats compatible with different virtual environment systems. The virtual garment 500 may be optimized for different rendering engines. The optimization may help to ensure substantially consistent appearance across different virtual platforms.

The virtual garment 500 may include interactive elements not present on the physical garment 200. The interactive elements may include color-changing features, particle effects, or other animations. The interactive elements may be triggered by user actions and/or events within the virtual environment.

The virtual garment 500 may be stored in digital asset repositories. The digital asset repositories may be accessible via the network. The virtual garment 500 may be downloaded to user devices. The user devices may include the mobile device 102. The user devices may include virtual reality headsets. The user devices may include gaming consoles. The user devices may include personal computers.

The virtual garment 500 may have associated access rights determined by ownership of the corresponding NFT. The NFT may represent ownership of the physical garment 200 and/or the virtual garment 500. The access rights may allow the owner to wear the virtual garment 500 on their digital avatar, to display the virtual garment 500 in virtual galleries, and/or to transfer the virtual garment 500 to other users.

The virtual garment 500 may include level-of-detail variations that provide different geometric complexity. Higher detail versions may be used when the virtual garment 500 is viewed closely and/or in a more capable engine. Lower detail versions may be used when the virtual garment 500 is viewed from a distance and/or in a less capable engine. The level-of-detail variations may optimize rendering performance and reduce computational load on rendering systems.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 600 may be employed in the performance of some or all of the stages disclosed with regard to the methods. Similarly, an apparatus may be employed in the performance of some or all of the stages of the methods. As such, the apparatus may comprise at least those architectural components found in computing device 600.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the depicted methods and systems disclosed herein.

### A. Method for Translation of Binary Data Embedded in a Garment

Consistent with embodiments of the present disclosure, a method may be performed by at least one of the aforementioned modules. The method may be embodied as, for example, but not limited to, computer instructions, which, when executed, perform the method.

The method may provide a comprehensive approach for translating binary code displayed on custom garments into human-readable ASCII text using a mobile device. The method may begin when a mobile application executing on the mobile device receives user input to activate the application. The mobile application may then activate a camera of the mobile device. The camera may capture image data of a binary code pattern displayed on a custom garment. The mobile application may process the captured image data using optical character recognition to identify individual binary digits within the binary code pattern. The mobile application may convert the identified binary digits to ASCII text using a binary-to-ASCII conversion algorithm. The mobile application may display the ASCII text on a display of the mobile device in real-time.

The method may enable rapid translation of binary code without requiring manual input of binary digits. The user may simply aim the camera at the binary code design on the garment. The processor may execute instructions to automatically recognize the binary pattern within the captured image. The conversion to ASCII text may occur substantially instantaneously using the locally stored conversion table in memory. The translation may occur without requiring network connectivity through the network interface, enabling functionality in areas with limited or no wireless coverage. The lightweight design of the application may minimize storage requirements in memory while maintaining rapid processing capabilities through the processor. The method may provide an efficient solution for scenarios requiring quick identification or information retrieval from binary-coded garments across multiple use cases.

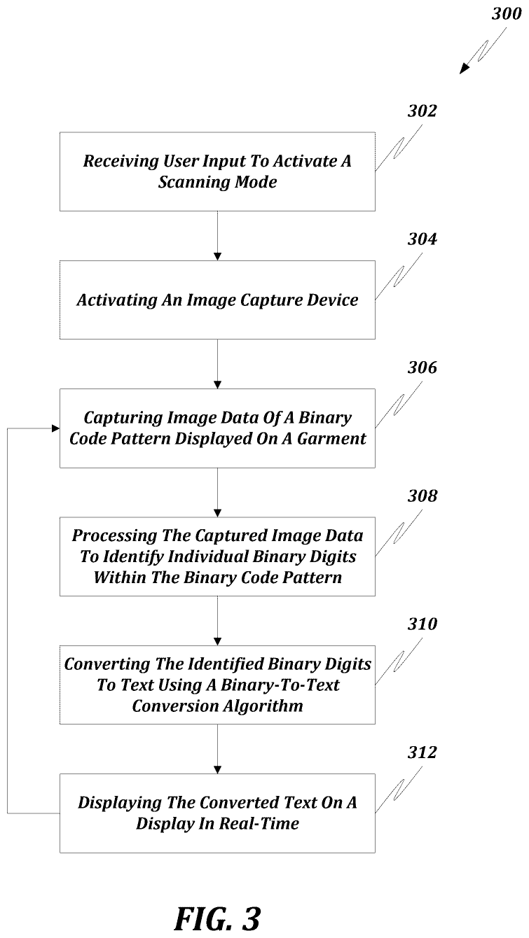

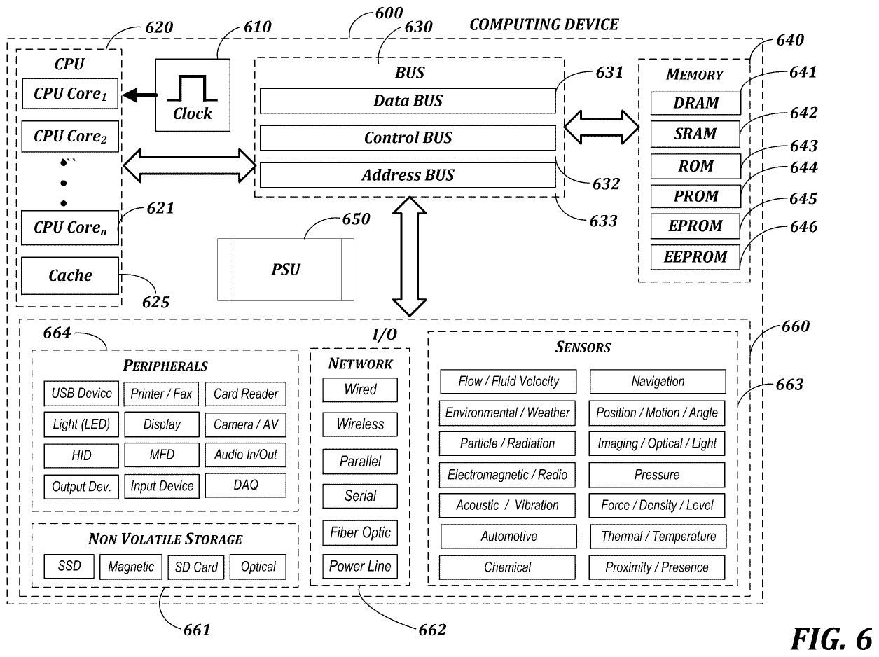

FIG. 3 is a flow chart setting forth the general stages involved in a method 300 consistent with an embodiment of the disclosure for translation of binary data embedded in a garment using the platform 100. Method 300 may be implemented using a computing device 600 or any other component associated with platform 100 as described in more detail below with respect to FIG. 6.

The method 300 may provide a comprehensive approach for translating binary code displayed on custom garments into human-readable ASCII text using a mobile device. The method may enable rapid, real-time translation without requiring manual input of binary digits. The method may operate entirely on the mobile device without requiring network connectivity.

The method 300 may begin at stage 302 with receiving user input to activate a scanning mode. The mobile application executing on the mobile device 102 may receive user input through various interaction mechanisms. The user input may comprise a tap on an application icon displayed on a home screen of the mobile device 102. The user input may comprise a voice command spoken by the user and detected by a microphone of the mobile device 102, a gesture detected by a touchscreen of the mobile device, activation through a widget or shortcut configured on the mobile device, and/or the like.

The mobile application may be installed on the mobile device 102 prior to receiving the user input. The installation may occur through downloading from an application distribution platform, sideloading from a file, and/or pre-installation by a device manufacturer or carrier.

Upon receiving the user input, the mobile application may initialize various software modules. The mobile application may load executable code from the memory into active random access memory. The mobile application may establish communication pathways between different functional components. The mobile application may verify that necessary permissions have been granted by the operating system of the mobile device 102. The necessary permissions may include permission to access the camera and the display.

The mobile application may present a user interface on the display of the mobile device 102 upon activation. The user interface may include visual elements indicating that the scanning mode is active. The user interface may include instructions for positioning the mobile device 102 relative to a garment 200, a viewfinder region showing a live camera feed, and/or optional control buttons for adjusting settings or capturing images.

In stage 304, the mobile application may activate the image capture device of the mobile device 102. The activation may occur automatically upon receiving the user input to activate the scanning mode. The activation may occur in response to a separate user action after the application has been launched.

The mobile application may send an activation command to the camera through an application programming interface provided by the operating system. The activation command may cause the camera to power on image sensor hardware, initialize optical components, and prepare for image capture operations.

The mobile application may configure various camera settings upon activation. The mobile application may set a frame rate for continuous image capture. As non-limiting examples, the frame rate may be thirty frames per second, sixty frames per second, etc. The frame rate may be adjusted based at least in part on processing capabilities of the processor 110. The mobile application may configure autofocus settings (to maintain sharp focus on objects at varying distances), exposure settings (to optimize image brightness under different lighting conditions), white balance settings (to ensure accurate color representation), and/or the like.

The image capture device may begin capturing image data upon activation. The image data may be transmitted from the camera through a hardware and/or software interface. The image data may be stored temporarily in the memory for processing. The image data may be displayed on the display to provide visual feedback to the user.

The mobile application may monitor the status of the image capture device during operation. The mobile application may detect if the device becomes unavailable or encounters an error. Responsive to any encountered error, the mobile application may provide error messages to the user, and/or attempt to reinitialize the camera 140 if temporary failures occur.

In stage 306, the system may capture image data of a binary code pattern displayed on a garment 200. The binary code pattern may comprise the binary code design 210 applied to the garment 200. The binary code design 210 may be printed on the fabric of the garment 200, embroidered on the fabric of the garment, applied through heat transfer methods, and/or applied through other permanent or semi-permanent application techniques.

The user may position the mobile device 102 such that the camera has a clear view of the binary code design 210. The user may hold the mobile device 102 at a distance that allows the entire binary code design 210 to fit within the field of view of the camera (e.g., from several inches away to several feet away). The optimal distance may depend on the size of the binary code design 210 and/or the focal characteristics of the camera 140.

The mobile device 102 may capture one or more high-resolution images when the binary code design 210 is positioned within the field of view. The camera may capture a continuous stream of images at the configured frame rate. The continuous capture may enable real-time processing as the mobile device 102 moves relative to the garment 200. The continuous capture may enable processing of binary code patterns even when the binary code design 210 extends beyond the field of view of the camera.

The captured image data may include pixel values representing light intensity at different positions within the image, and/or color information for each pixel. The captured image data may be stored in a standard image format (e.g., JPEG, PNG, a raw sensor data format, etc.).

The mobile application may analyze the captured image data to determine if a binary code pattern is present. The mobile application may apply preliminary image processing to enhance the visibility of potential binary code patterns, such as (but not limited to) contrast adjustment, brightness normalization, noise reduction filtering, and/or the like.

In stage 308, the mobile application may process the captured image data using optical character recognition to identify individual binary digits within the binary code pattern. The processing may be performed by the mobile device executing specialized algorithms stored in the memory 120. The processing may occur substantially in real-time as image data is captured by the camera.

The mobile application may apply image enhancement techniques to the captured image data. The image enhancement may improve the clarity and contrast of the binary code pattern. The image enhancement may include applying edge detection algorithms to identify boundaries between binary digits and background regions, applying morphological operations to clean up noise and artifacts, applying perspective correction to account for viewing angles that are not perpendicular to the garment surface.

The mobile application may identify regions of interest within the processed image. The regions of interest may correspond to areas containing potential binary code patterns. The identification may be based on detecting regular patterns of high-contrast elements, specific spatial arrangements characteristic of binary code representations, and/or alignment patterns or markers included in the binary code design 210.

The mobile application may segment individual characters within the identified regions of interest. The segmentation may separate each binary digit from adjacent digits, and/or determine boundaries around each character. The segmentation may account for variations in spacing between characters, and/or variations in character size or orientation.

The mobile application may classify each segmented character as either a zero or a one. The classification may be performed by comparing the segmented character image to reference templates stored in the memory. The reference templates may represent typical appearances of zero and one characters in various fonts and styles. Additionally or alternatively, the classification may be performed using machine learning models trained to recognize binary digits. The classification may generate a confidence score indicating the likelihood that the classification is correct.

The mobile application may assemble the classified binary digits into a complete binary sequence. The assembly may order the digits according to their spatial positions within the binary code pattern. The assembly may account for multi-line arrangements where binary digits are organized in rows or multi-column arrangements where binary digits are organized in columns. The assembly may generate a string of zeros and ones representing the complete binary code.

The mobile application may validate the recognized binary sequence. The validation may check for expected sequence lengths. In some embodiments, the validation may check for error detection codes embedded in the binary sequence. The validation may compare the sequence against known valid patterns. The validation may flag sequences that appear incomplete or corrupted.

The method 300 may continue to stage 310, where the platform may convert the identified binary digits to text (e.g., in ASCII or Unicode formats) using a binary-to-ASCII (or binary to Unicode) conversion algorithm. The conversion may transform the binary sequence into human-readable text characters. The conversion may be performed by the binary translation module executing conversion logic.

The mobile application may access a conversion table stored in local memory on the mobile device 102. The conversion table may map binary sequences to corresponding characters. The conversion table may be implemented as a lookup table data structure, or as a mathematical function that computes character values from binary inputs. The conversion table may support standard ASCII encoding, extended ASCII encoding, and/or Unicode encoding for international character sets.

In some embodiments, the conversion may include the mobile application parsing the binary sequence into fixed-length segments, with each segment representing one character in the text. The segment length may be eight bits for standard ASCII encoding, or sixteen bits for Unicode encoding. The parsing may align segment boundaries according to the encoding scheme being used.

The mobile application may look up each binary segment in the conversion table and retrieve the character corresponding to the binary value of the segment. The lookup may handle special cases where binary values do not correspond to printable characters. As one example, the lookup may substitute placeholder characters for non-printable values. The lookup may skip or ignore invalid binary sequences.

The mobile application may concatenate the retrieved characters to form a complete text string. The concatenation may preserve the order of characters as they appeared in the binary sequence, and may apply formatting rules such as (but not limited to) inserting spaces or line breaks. The concatenation may generate a final text output representing the decoded message.

The mobile application may validate the converted text. The validation may check if the text contains expected content, and/or matches patterns associated with valid messages. In some embodiments, the validation may compare the text against a database of authorized messages. The validation may flag text that appears to be corrupted or invalid.

In stage 312, the mobile device 102 may display the converted text on the display in real-time. The display may present the translated text to the user substantially immediately after conversion is complete. The display may update continuously as new binary code patterns are captured and translated.

The mobile application may format the ASCII text for readability on the display. The formatting may include selecting an appropriate font (e.g., a sans-serif font for clarity, a monospace font for alignment, etc.). The formatting may include selecting an appropriate text size. In some embodiments, the text size may be adjustable by the user through application settings.

The mobile application may select colors for the text and/or background to maximize contrast. For example, the text color may be black on a white background or white on a black background. The text color may be selected based on ambient lighting conditions detected by sensors on the mobile device 102. The background may be semi-transparent to allow the camera view to remain visible.

The mobile application may position the ASCII text at a specific location on the display (e.g., in a dedicated text output region). The text may be positioned to avoid obscuring important visual elements.

The mobile application may update the displayed text in real-time as new translations become available. The update may occur within milliseconds of completing the conversion process. In some embodiments, the update may provide smooth transitions between different text values, and may include animation effects to draw attention to changes. The update may maintain a history of recent translations that can be scrolled through by the user.

The mobile application may provide additional visual feedback on the display 130, including (but not limited to) indicators showing that a binary code pattern has been detected., indicators showing the confidence level of the translation, and/or the like. The visual feedback may include highlighting or outlining the detected binary code region in the camera view.

The mobile application may provide audio feedback in addition to visual display. The audio feedback may include a sound effect when a successful translation occurs. The audio feedback may include text-to-speech output reading the translated text aloud. The audio feedback may be configurable by the user through application settings.

The mobile application may maintain the display until the user exits the scanning mode. The user may exit by pressing a back button. The user may exit by closing the application. The user may exit by switching to a different application. Upon exit, the mobile application may clear temporary data from the memory 120. The mobile application may not permanently store captured images or translated text to preserve user privacy.

### IV. Hardware Architecture

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 600. The computing device 600 may comprise, but not be limited to, the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exascale supercomputer, a mainframe, or a quantum computer;

A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack-mounted, a workstation, an industrial device, a raspberry pi, a desktop, or an embedded device;

Platform 100 may be hosted on a centralized server or a cloud computing service. Although method 300 has been described to be performed by a computing device 600, it should be understood that, in some embodiments, different operations may be performed by a plurality of the computing devices 600 in operative communication on at least one network.

Embodiments of the present disclosure may comprise a system having a central processing unit (CPU) 620, a bus 630, a memory unit 640, a power supply unit (PSU) 650, and one or more Input/Output (I/O) units. The CPU 620 coupled to the memory unit 640 and the plurality of I/O units 660 via the bus 630, all of which are powered by the PSU 650. It should be understood that, in some embodiments, each disclosed unit may actually be a plurality of such units for redundancy, high availability, and/or performance purposes. The combination of the presently disclosed units is configured to perform the stages of any method disclosed herein.

FIG. 6 is a block diagram of a system including computing device 600. Consistent with an embodiment of the disclosure, the aforementioned CPU 620, the bus 630, the memory unit 640, a PSU 650, and the plurality of I/O units 660 may be implemented in a computing device, such as computing device 600 of FIG. 6. Any suitable combination of hardware, software, or firmware may be used to implement the aforementioned units. For example, the CPU 620, the bus 630, and the memory unit 640 may be implemented with computing device 600 or any of other computing devices 600, in combination with computing device 600. The aforementioned system, device, and components are examples and other systems, devices, and components may comprise the aforementioned CPU 620, the bus 630, and the memory unit 640, consistent with embodiments of the disclosure.

At least one computing device 600 may be embodied as any of the computing elements illustrated in all of the attached figures. A computing device 600 does not need to be electronic, nor even have a CPU 620, nor bus 630, nor memory unit 640. The definition of the computing device 600 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 600, especially if the processing is purposeful.

With reference to FIG. 6, a system consistent with an embodiment of the disclosure may include a computing device, such as computing device 600. In some configurations, the computing device 600 may include at least one clock module 610, at least one CPU 620, at least one bus 630, and at least one memory unit 640, at least one PSU 650, and at least one I/O 660 module, wherein I/O module may be comprised of, but not limited to a non-volatile storage sub-module 661, a communication sub-module 662, a sensors sub-module 663, and a peripherals sub-module 664.

In a system consistent with an embodiment of the disclosure, the computing device 600 may include the clock module 610, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 620, the central component of modern computers, which relies on a clock signal. The clock 610 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 600 may use a “clock multiplier” which multiplies a lower frequency external clock to the appropriate clock rate of the CPU 620. This allows the CPU 620 to operate at a much higher frequency than the rest of the computing device 600, which affords performance gains in situations where the CPU 620 does not need to wait on an external factor (like memory 640 or input/output 660). Some embodiments of the clock 610 may include dynamic frequency change, where, the time between clock edges can vary widely from one edge to the next and back again.

In a system consistent with an embodiment of the disclosure, the computing device 600 may include the CPU 620 comprising at least one CPU Core 621. In other embodiments, the CPU 620 may include a plurality of identical CPU cores 621, such as, but not limited to, homogeneous multi-core systems. It is also possible for the plurality of CPU cores 621 to comprise different CPU cores 621, such as, but not limited to, heterogeneous multi-core systems, big. LITTLE systems and some AMD accelerated processing units (APU). The CPU 620 reads and executes program instructions which may be used across many application domains, for example, but not limited to, general purpose computing, embedded computing, network computing, digital signal processing (DSP), and graphics processing (GPU). The CPU 620 may run multiple instructions on separate CPU cores 621 simultaneously. The CPU 620 may be integrated into at least one of a single integrated circuit die, and multiple dies in a single chip package. The single integrated circuit die and/or the multiple dies in a single chip package may contain a plurality of other elements of the computing device 600, for example, but not limited to, the clock 610, the bus 630, the memory 640, and I/O 660.

The CPU 620 may contain cache 622 such as but not limited to a level 1 cache, a level 2 cache, a level 3 cache, or combinations thereof. The cache 622 may or may not be shared amongst a plurality of CPU cores 621. The cache 622 sharing may comprise at least one of message passing and inter-core communication methods used for the at least one CPU Core 621 to communicate with the cache 622. The inter-core communication methods may comprise, but not be limited to, bus, ring, two-dimensional mesh, and crossbar. The aforementioned CPU 620 may employ symmetric multiprocessing (SMP) design.

The one or more CPU cores 621 may comprise soft microprocessor cores on a single field programmable gate array (FPGA), such as semiconductor intellectual property cores (IP Core). The architectures of the one or more CPU cores 621 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 621, for example, but not limited to Instruction-level parallelism (ILP) such as, but not limited to, superscalar pipelining, and Thread-level parallelism (TLP).

Consistent with the embodiments of the present disclosure, the aforementioned computing device 600 may employ a communication system that transfers data between components inside the computing device 600, and/or the plurality of computing devices 600. The aforementioned communication system will be known to a person having ordinary skill in the art as a bus 630. The bus 630 may embody internal and/or external hardware and software components, for example, but not limited to a wire, an optical fiber, various communication protocols, and/or any physical arrangement that provides the same logical function as a parallel electrical bus. The bus 630 may comprise at least one of a parallel bus, wherein the parallel bus carries data words in parallel on multiple wires; and a serial bus, wherein the serial bus carries data in bit-wise serial form. The bus 630 may embody a plurality of topologies, for example, but not limited to, a multidrop/electrical parallel topology, a daisy chain topology, and connected by switched hubs, such as a USB bus. The bus 630 may comprise a plurality of embodiments, for example, but not limited to:
Internal data bus (data bus) 631/Memory bus
Control bus 632
Address bus 633
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 600 may employ hardware integrated circuits that store information for immediate use in the computing device 600, known to persons having ordinary skill in the art as primary storage or memory 640. The memory 640 operates at high speed, distinguishing it from the non-volatile storage sub-module 661, which may be referred to as secondary or tertiary storage, which provides relatively slower-access to information but offers higher storage capacity. The data contained in memory 640, may be transferred to secondary storage via techniques such as, but not limited to, virtual memory and swap. The memory 640 may be associated with addressable semiconductor memory, such as integrated circuits consisting of silicon-based transistors, that may be used as primary storage or for other purposes in the computing device 600. The memory 640 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 641, Static Random-Access Memory (SRAM) 642, CPU Cache memory 625, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 643, Programmable ROM (PROM) 644, Erasable PROM (EPROM) 645, Electrically Erasable PROM (EEPROM) 646 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 600 may employ a communication system between an information processing system, such as the computing device 600, and the outside world, for example, but not limited to, human, environment, and another computing device 600. The aforementioned communication system may be known to a person having ordinary skill in the art as an Input/Output (I/O) module 660. The I/O module 660 regulates a plurality of inputs and outputs with regard to the computing device 600, wherein the inputs are a plurality of signals and data received by the computing device 600, and the outputs are the plurality of signals and data sent from the computing device 600. The I/O module 660 interfaces with a plurality of hardware, such as, but not limited to, non-volatile storage 661, communication devices 662, sensors 663, and peripherals 664. The plurality of hardware is used by at least one of, but not limited to, humans, the environment, and another computing device 600 to communicate with the present computing device 600. The I/O module 660 may comprise a plurality of forms, for example, but not limited to channel I/O, port mapped I/O, asynchronous I/O, and Direct Memory Access (DMA).

Consistent with the embodiments of the present disclosure, the aforementioned computing device 600 may employ a non-volatile storage sub-module 661, which may be referred to by a person having ordinary skill in the art as one of secondary storage, external memory, tertiary storage, off-line storage, and auxiliary storage. The non-volatile storage sub-module 661 may not be accessed directly by the CPU 620 without using an intermediate area in the memory 640. The non-volatile storage sub-module 661 may not lose data when power is removed and may be orders of magnitude less costly than storage used in memory 640. Further, the non-volatile storage sub-module 661 may have a slower speed and higher latency than in other areas of the computing device 600. The non-volatile storage sub-module 661 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (661) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) Digital Data Storage

Consistent with the embodiments of the present disclosure, the computing device 600 may employ a communication sub-module 662 as a subset of the I/O module 660, which may be referred to by a person having ordinary skill in the art as at least one of, but not limited to, a computer network, a data network, and a network. The network may allow computing devices 600 to exchange data using connections, which may also be known to a person having ordinary skill in the art as data links, which may include data links between network nodes. The nodes may comprise networked computer devices 600 that may be configured to originate, route, and/or terminate data. The nodes may be identified by network addresses and may include a plurality of hosts consistent with the embodiments of a computing device 600. Examples of computing devices that may include a communication sub-module 662 include, but are not limited to, personal computers, phones, servers, drones, and networking devices such as, but not limited to, hubs, switches, routers, modems, and firewalls.

Two nodes can be considered networked together when one computing device 600 can exchange information with the other computing device 600, regardless of any direct connection between the two computing devices 600. The communication sub-module 662 supports a plurality of applications and services, such as, but not limited to World Wide Web (WWW), digital video and audio, shared use of application and storage computing devices 600, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 662 may comprise a plurality of size, topology, traffic control mechanisms and organizational intent policies. The communication sub-module 662 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line Communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 600 may employ a sensors sub-module 663 as a subset of the I/O 660. The sensors sub-module 663 comprises at least one of the device, module, or subsystem whose purpose is to detect events or changes in its environment and send the information to the computing device 600. Sensors may be sensitive to the property they are configured to measure, may not be sensitive to any property not measured but be encountered in its application, and may not significantly influence the measured property. The sensors sub-module 663 may comprise a plurality of digital devices and analog devices, wherein if an analog device is used, an Analog to Digital (A-to-D) converter must be employed to interface the said device with the computing device 600. The sensors may be subject to a plurality of deviations that limit sensor accuracy. The sensors sub-module 663 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection / pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 600 may employ a peripherals sub-module 664 as a subset of the I/O 660. The peripheral sub-module 664 comprises ancillary devices used to put information into and get information out of the computing device 600. There are 3 categories of devices comprising the peripheral sub-module 664, which exist based on their relationship with the computing device 600, input devices, output devices, and input/output devices. Input devices send at least one of data and instructions to the computing device 600. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 600. Output devices convert electronically generated information into a form that can be presented to humans. Input/output devices that perform both input and output functions. It should be understood by a person having ordinary skill in the art that the ensuing are non-limiting embodiments of the aforementioned peripheral sub-module 664:
Input Devices
   Human Interface Devices (hid), Such As, but Not Limited to, Pointing Device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 600. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 600 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 600. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 662), data storage devices (non-volatile storage 661), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method for real-time binary-to-text translation from encoded garments using a mobile device, the method comprising:
receiving, by a mobile application executing on the mobile device, user input to activate a scanning mode;
activating, by the mobile application, an image capture device of the mobile device;
capturing, by the image capture device, image data of a binary code pattern displayed on a custom garment;
processing, by the mobile application, the captured image data using optical character recognition to identify individual binary digits within the binary code pattern;
converting, by the mobile application, the identified binary digits to ASCII text using a binary-to-text conversion algorithm; and
displaying, by the mobile application, the text on a display of the mobile device in real-time.

2. The method of claim 1, further comprising:
continuously repeating the capturing, processing, converting, and displaying steps to provide real-time translation updates as the image capture device moves relative to the custom garment.

3. The method of claim 1, wherein the binary code pattern comprises a unique identifier associated with a specific user.

4. The method of claim 3, wherein the text comprises identification information for the specific user.

5. The method of claim 1, wherein converting the identified binary digits to text comprises:
accessing a binary-to-American Standard Code for Information Interchange (ASCII) lookup table stored in memory of the mobile device;
mapping each group of binary digits to corresponding ASCII characters using the lookup table; and
assembling the ASCII characters into the ASCII text.

6. The method of claim 1, further comprising:
verifying, by the mobile application, that the binary code pattern conforms to an authorized format before performing the converting and displaying steps.

7. The method of claim 1, wherein the custom garment comprises a hooded sweatshirt having the binary code pattern printed on a visible surface.

8. A system for translating binary code patterns on garments to text, the system comprising:
a custom garment displaying a unique binary code pattern;
a mobile computing device comprising:
an image capture device configured to capture image data;
a display;
a processor; and
memory storing instructions that, when executed by the processor, cause the mobile computing device to:
activate the image capture device in response to user input;
capture image data of the binary code pattern on the custom garment;
process the captured image data using optical character recognition to identify binary digits within the binary code pattern;
convert the identified binary digits to text using a conversion algorithm; and
display the text on the display in real-time.

9. The system of claim 8, wherein the memory further stores instructions that, when executed by the processor, cause the mobile computing device to:
continuously capture successive images of the binary code pattern;
process each successive image to identify binary digits;
update the ASCII text based on the processed images; and
refresh the display with updated ASCII text in real-time.

10. The system of claim 8, wherein the unique binary code pattern encodes identification information for a specific user.

11. The system of claim 8, wherein the memory stores a binary-to-ASCII conversion table, and wherein converting the identified binary digits comprises:
accessing the conversion table;
mapping groups of binary digits to ASCII characters using the conversion table; and
assembling the ASCII characters into the ASCII text.

12. The system of claim 8, wherein the instructions are configured to process binary code patterns exclusively from garments associated with a predetermined brand.

13. The system of claim 8, wherein the memory further stores instructions that, when executed by the processor, cause the mobile computing device to:
validate the binary code pattern against authorized pattern formats before performing conversion and display operations.

14. A non-transitory computer-readable medium storing instructions that, when executed by one or more processors, cause the one or more processors to perform operations comprising:
receiving, by a mobile application executing on a mobile device, user input to activate a scanning mode;
activating, by the mobile application, an image capture device of the mobile device;
capturing, by the image capture device, image data of a binary code pattern displayed on a custom garment;
processing, by the mobile application, the captured image data using optical character recognition to identify individual binary digits within the binary code pattern;
converting, by the mobile application, the identified binary digits to text using a binary-to-text conversion algorithm; and
displaying, by the mobile application, the converted text on a display of the mobile device in real-time.

15. The non-transitory computer-readable medium of claim 14, the operations further comprising:
continuously repeating the capturing, processing, converting, and displaying steps to provide real-time translation updates as the image capture device moves relative to the custom garment.

16. The non-transitory computer-readable medium of claim 14, wherein the binary code pattern comprises a unique identifier associated with a specific user.

17. The non-transitory computer-readable medium of claim 16, wherein the text comprises identification information for the specific user.

18. The non-transitory computer-readable medium of claim 14, wherein converting the identified binary digits to text comprises:
accessing a binary-to-ASCII lookup table stored in memory of the mobile device;
mapping each group of binary digits to corresponding ASCII characters using the lookup table; and
assembling the ASCII characters into the text.

19. The non-transitory computer-readable medium of claim 14, the operations further comprising:
verifying, by the mobile application, that the binary code pattern conforms to an authorized format before performing the converting and displaying steps.

20. The non-transitory computer-readable medium of claim 14, wherein converting the identified binary digits to text comprises:
accessing a binary-to-Unicode lookup table stored in memory of the mobile device;
mapping each group of binary digits to corresponding Unicode characters using the lookup table; and
assembling the Unicode characters into the text.
